(19) United States
(12) Patent Application Publication
(10) Pub. No.: US 2021/0409993 A1
(43) Pub. Date: Dec. 30, 2021

(54) INTERFERENCE MANAGEMENT FOR SIDELINK ON RESOURCES SHARED WITH DIRECT LINK

(71) Applicant: QUALCOMM INCORPORATED, San Diego, CA (US)

(72) Inventors: Seyed Ali Akbar Fakoorian, San Diego, CA (US); Wei Yang, San Diego, CA (US); Krishna Kiran Mukkavilli, San Diego, CA (US); Seyedkianoush Hosseini, San Diego, CA (US); Wanshi Chen, San Diego, CA (US); Tingfang Ji, San Diego, CA (US); Hwan Joon Kwon, San Diego, CA (US); Peter Gaal, San Diego, CA (US); Huilin Xu, Temecula, CA (US)

(21) Appl. No.: 17/302,761

(22) Filed: May 11, 2021

Related U.S. Application Data
(60) Provisional application No. 63/044,328, filed on Jun. 25, 2020.

(51) Int. Cl. H04W 24/10; H04B 17/336; H04W 72/08; H04W 72/10

(52) U.S. Cl. CPC H04W 24/10; H04B 17/336; H04W 92/18; H04W 72/082; H04W 72/10; H04W 72/085

(57) ABSTRACT

Wireless communications systems and methods related to managing sidelink interference on resources shared with a direct link in a wireless communication network are provided. A first user equipment (UE) receives, from a base station (BS), a configuration indicating one or more sidelink interference measurement resources for determining an interference from a sidelink to a direct link of the BS. The first UE communicates, with a second UE, a reference signal in at least a first sidelink interference measurement resource of the one or more sidelink interference measurement resources, where one of the first UE or the second UE is associated with the sidelink, and where the other one of the first UE or the second UE is associated with the direct link.

### CROSS REFERENCE TO RELATED APPLICATIONS

The present application claims priority to and the benefit of U.S. Provisional Patent Application No. 63/044,328, filed Jun. 25, 2020, which is hereby incorporated by reference in its entirety as if fully set forth below and for all applicable purposes.

### TECHNICAL FIELD

This application relates to wireless communication systems, and more particularly to managing sidelink interference on resources shared with a direct link in a wireless communication network.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a base station (BS), the method includes determining one or more sidelink interference measurement resources for determining an interference from at least a first sidelink to a direct link, the first sidelink associated with a first user equipment (UE), and the direct link being between the BS and a second UE different from the first UE; and transmitting, to at least one of the first UE or the second UE, a configuration indicating the one or more sidelink interference measurement resources.

In an additional aspect of the disclosure, a method of wireless communication performed by a first user equipment (UE), the method includes receiving, from a BS, a configuration indicating one or more sidelink interference measurement resources for determining an interference from a sidelink to a direct link of the BS; and communicating, with a second UE, a reference signal in at least a first sidelink interference measurement resource of the one or more sidelink interference measurement resources, where one of the first UE or the second UE is associated with the sidelink, and where the other one of the first UE or the second UE is associated with the direct link.

In an additional aspect of the disclosure, a base station (BS) includes a processor configured to determine one or more sidelink interference measurement resources for determining an interference from at least a first sidelink to a direct link, the first sidelink associated with a first user equipment (UE), and the direct link being between the BS and a second UE different from the first UE; and a transceiver configured to transmit, to at least one of the first UE or the second UE, a configuration indicating the one or more sidelink interference measurement resources.

In an additional aspect of the disclosure, a first user equipment (UE) includes a transceiver configured to receive, from a BS, a configuration indicating one or more sidelink interference measurement resources for determining an interference from a sidelink to a direct link of the BS; and communicate, with a second UE, a reference signal in at least a first sidelink interference measurement resource of the one or more sidelink interference measurement resources, where one of the first UE or the second UE is associated with the sidelink, and where the other one of the first UE or the second UE is associated with the direct link.

In an additional aspect of the disclosure, a non-transitory computer-readable medium having program code recorded thereon, the program code includes code for causing a base station (BS) to determine one or more sidelink interference measurement resources for determining an interference from at least a first sidelink to a direct link, the first sidelink associated with a first user equipment (UE), and the direct link being between the BS and a second UE different from the first UE; and code for causing the BS to transmit, to at least one of the first UE or the second UE, a configuration indicating the one or more sidelink interference measurement resources.

In an additional aspect of the disclosure, a non-transitory computer-readable medium having program code recorded thereon, the program code includes code for causing a first user equipment (UE) to receive, from a BS, a configuration indicating one or more sidelink interference measurement resources for determining an interference from a sidelink to a direct link of the BS; and code for causing the first UE to communicate, with a second UE, a reference signal in at least a first sidelink interference measurement resource of the one or more sidelink interference measurement resources, where one of the first UE or the second UE is associated with the sidelink, and where the other one of the first UE or the second UE is associated with the direct link.

In an additional aspect of the disclosure, a base station (BS) includes means for determining one or more sidelink interference measurement resources for determining an interference from at least a first sidelink to a direct link, the first sidelink associated with a first user equipment (UE), and the direct link being between the BS and a second UE different from the first UE; and means for transmitting, to at least one of the first UE or the second UE, a configuration indicating the one or more sidelink interference measurement resources.

In an additional aspect of the disclosure, a first user equipment (UE) includes means for receiving, from a BS, a configuration indicating one or more sidelink interference measurement resources for determining an interference from a sidelink to a direct link of the BS; and means for communicating, with a second UE, a reference signal in at least a first sidelink interference measurement resource of the one or more sidelink interference measurement resources, where one of the first UE or the second UE is associated with the sidelink, and where the other one of the first UE or the second UE is associated with the direct link.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates an interference scenario in a wireless communication network according to some aspects of the present disclosure.

FIG. 4 is a signaling diagram illustrating an interference management method according to some aspects of the present disclosure.

FIG. 5 illustrates an exemplary sidelink interference measurement and report configuration according to some aspects of the present disclosure.

FIG. 6 illustrates a sidelink interference measurement and report scheme according to some aspects of the present disclosure.

FIG. 7 is a signaling diagram illustrating an interference management method according to some aspects of the present disclosure.

FIG. 8 is a signaling diagram illustrating an interference management method according to some aspects of the present disclosure.

FIG. 9 is a signaling diagram illustrating an interference management method according to some aspects of the present disclosure.

FIG. 10 is a signaling diagram illustrating an interference management method according to some aspects of the present disclosure.

FIG. 11 is a signaling diagram illustrating an interference management method according to some aspects of the present disclosure.

FIG. 12 illustrates an interference management scheme according to some aspects of the present disclosure.

FIG. 13 is a block diagram of an exemplary base station (BS) according to some aspects of the present disclosure.

FIG. 14 is a block diagram of an exemplary user equipment (UE) according to some aspects of the present disclosure.

FIG. 15 is a flow diagram of a wireless communication method according to some aspects of the present disclosure.

FIG. 16 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1 M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. Use cases for sidelink communication may include V2X, enhanced mobile broadband (eMBB), industrial IoT (IIoT), and/or NR-lite.

As used herein, the term “sidelink UE” can refer to a user equipment device performing a device-to-device communication or other types of communications with another user equipment device independent of any tunneling through the BS (e.g., gNB) and/or an associated core network. As used herein, the term “sidelink transmitting UE” can refer to a user equipment device performing a sidelink transmission operation. As used herein, the term “sidelink receiving UE” can refer to a user equipment device performing a sidelink reception operation. A sidelink UE may operate as a sidelink transmitting UE at one time and as a receiving sidelink UE at another time. In NR, a sidelink between two UEs (without tunneling through a BS and/or a core network) is referred to as a PC5 interface, and a direct link between a BS and a UE is referred to as a Uu interface. Accordingly, a UE in communication with another UE over a sidelink may be referred to as a PC5 UE, and a UE in communication with a BS over a direct link may be referred to as a Uu UE.

NR supports two modes of radio resource allocations (RRA), a mode-1 RRA and a mode-2 RRA, for sidelink over a licensed spectrum. The mode-1 RRA supports network controlled RRA that can be used for in-coverage sidelink communication. For instance, a serving BS (e.g., gNB) may determine a radio resource on behalf of a sidelink UE and transmit an indication of the radio resource to the sidelink UE. In some aspects, the serving BS grants a sidelink transmission with downlink control information (DCI). For this mode, however, there is significant base station involvement and is only operable when the sidelink UE is within the coverage area of the serving BS. The mode-2 RRA supports autonomous RRA that can be used for out-of-coverage sidelink UEs or partial-coverage sidelink UEs. For instance, a serving BS may configure a sidelink UE (e.g., while in coverage of the serving BS) with one or more sidelink resource pools which may be used for sidelink when the sidelink UE is out of the coverage of the serving BS. In mode-2 RRA, the sidelink UE autonomously selects a sidelink resource from the preconfigured sidelink resource pool and transmits a sidelink transmission (e.g., SCI and/or sidelink data) in the selected resource. The sidelink transmitting UE may include in the SCI an indication indicating that the sidelink resource is reserved for transmission. Other sidelink UEs may monitor SCI in the sidelink resource pool and refrain from selecting a sidelink resource when a corresponding SCI indicates the sidelink resource is occupied or reserved. In some other examples, the BS may configure a sidelink UE (e.g., while in coverage of the serving BS) with configured grant resources for sidelink. Configured grant resources can be recurring, for example, at a certain periodicity. The sidelink UE may utilize the configured grant resources for sidelink transmissions without having to receive an individual sidelink scheduling grant from the BS for each configured grant resource.

In a certain aspect, a network or a BS may allocate one or more resources for sharing between sidelink transmissions and direct link transmissions (e.g., UL and/or DL transmissions). A sidelink may be between two UEs, a sidelink transmitting UE and a sidelink receiving UE. A direct link may be between a BS and a UE, which may be referred to as a direct link UE. The one or more resources may include DL resources that may be utilized by the BS to transmit DL communications to the direct link UE. When the sidelink shares a DL resource of the direct link and the sidelink transmitting UE is located nearby the direct link UE, a transmission from the sidelink transmitting UE over the sidelink can interfere with the DL communications from the BS to the direct link UE over the direct link. In other words, the sidelink transmitting UE is an aggressor of the interference on the direct link, and the direct link UE is a victim of the interference. The direct link UE performing DL reception may be referred to as a direct link receiving UE.

The present application describes mechanisms for managing interference from a sidelink to a direct link when the sidelink and the direct link shares a transmission resource. For example, a BS may allocate one or more sidelink interference measurement resources for determining an interference from at least a first sidelink to a direct link. The first sidelink may be associated with a first UE, and the direct link may be between the BS and a second UE different from the first UE. The first UE may be a sidelink transmitting UE that initiates a transmission over the first sidelink in the shared transmission resource. The second UE may be a direct link receiving UE that receives a DL transmission from the BS in the shared transmission resource. The first UE may be located nearby the second UE, and thus a transmission from the first UE can cause interference to the DL reception at the second UE. The BS may transmit a configuration indicating the one or more sidelink interference measurement resources to at least one of the first UE or the second UE. The BS may transmit the configuration based on the first sidelink sharing the transmission resource (e.g., configured for DL communication over the direct link).

In some aspects, the configuration may indicate at least one of a measurement report type, a reference signal type, a bandwidth, a subcarrier spacing, a sidelink traffic priority, or a direct link traffic priority associated with each of the one or more sidelink interference measurement resources. The measurement report type may include a reference signal received power (RSRP) or a received signal strength indicator (RSSI). The reference signal type may include a wideband reference signal or a narrowband signal. The wideband reference signal may be a sounding reference signal (SRS) or a channel state information-reference signal (CSI-RS). The narrowband reference signal may be a demodulation reference signal (DMRS) or a sidelink synchronization signal. A sidelink traffic priority may refer to the traffic priority of a sidelink or a sidelink transmission over the sidelink. A direct link traffic priority may refer to the traffic priority of a direct link or a DL transmission over the direct link.

In some aspects, the BS may configure the first UE (the aggressor) to transmit a reference signal in a first sidelink interference measurement resource of the one or more sidelink interference measurement resource and may configure the second UE (the victim) to determine and report an interference measurement and/or a traffic priority of the sidelink based on the first sidelink interference measurement resource. Accordingly, the first UE may transmit a reference signal in the first sidelink interference measurement resource in accordance with the configuration. The second UE may receive the reference signal from the first sidelink interference measurement resource and determine an interference measurement from the reference signal in accordance with the configuration. The second UE may transmit a report indicating the interference measurement and/or the sidelink traffic priority. The BS may determine whether to mute (or cancel) a transmission of the first UE over the sidelink or a DL transmission over the direct link or whether to reduce a transmission power over the direct link or a transmission power over the sidelink, for example, based on the received report and/or a traffic priority of the direct link. In some aspects, the second UE may determine autonomously (without being instructed by the BS) whether to request the first UE to mute a sidelink transmission or reduce a sidelink transmission power over the sidelink based on the interference measurement, the traffic priority of the sidelink, and/or the traffic priority of the direct link.

In some aspects, the BS may configure the second UE (the victim) to transmit a reference signal in a first sidelink interference measurement resource of the one or more sidelink interference measurement resource and configure the first UE (the aggressor) to determine an interference measurement and/or a traffic priority of the direct link based on the first sidelink interference measurement resource. Accordingly, the second UE may transmit a reference signal in the first sidelink interference measurement resource in accordance with the configuration. The reference signal may be similar to a clear-to-send (CTS) signal. The first UE may monitor for the reference signal from the first sidelink interference measurement resource and determine an interference measurement upon detecting the reference signal in accordance with the configuration. In some aspects, the first UE may determine autonomously (without being instructed by the BS) whether to mute (or cancel) a sidelink transmission or reduce a sidelink transmission power over the sidelink based on the interference measurement, the traffic priority of the direct link, and/or a traffic priority of the sidelink. In some aspects, the first UE may monitor for an interference feedback indication from the BS and/or the second UE and may determine whether to mute a sidelink transmission or reduce a sidelink transmission power over the sidelink based on the interference feedback indication.

Aspects of the present disclosure can provide several benefits. For example, configuring resources for sidelink interference measurements and reports allows the BS to manage interference from a sidelink to a direct link. For instance, the BS may allocate resources for sharing between the sidelink and the direct link and may reclaim or reallocate a shared resource for the direct link or for the sidelink based on traffic priorities of the sidelink and the direct link. The BS may also allow the sidelink to continue to share the resources with the direct link when the interference is low. The BS may also control the amount of interference from the sidelink to the direct link by controlling a transmission power over the direct link and/or a transmission power over the sidelink. Allowing the BS to have a full control of interference management (e.g., a centralized interference management) can provide the BS with a complete view of interference between the sidelink and the direct link, and thus the BS can provide optimal support of priority and interference control. Alternatively, allowing a sidelink transmitting UE (the aggressor) or a direct link receiving UE (the victim) to determine autonomously (without being instructed by the BS) whether to mute a sidelink transmission or reduce a sidelink transmission power over the sidelink may be suitable when the sidelink transmitting UE is out of the coverage of the BS and/or when mode 2-RRA is used for sidelink. Thus, the present disclosure can provide flexible and efficient usages and sharing of resources between a direct link and a sidelink with a minimal interference or controlled interference from the sidelink to the direct link.

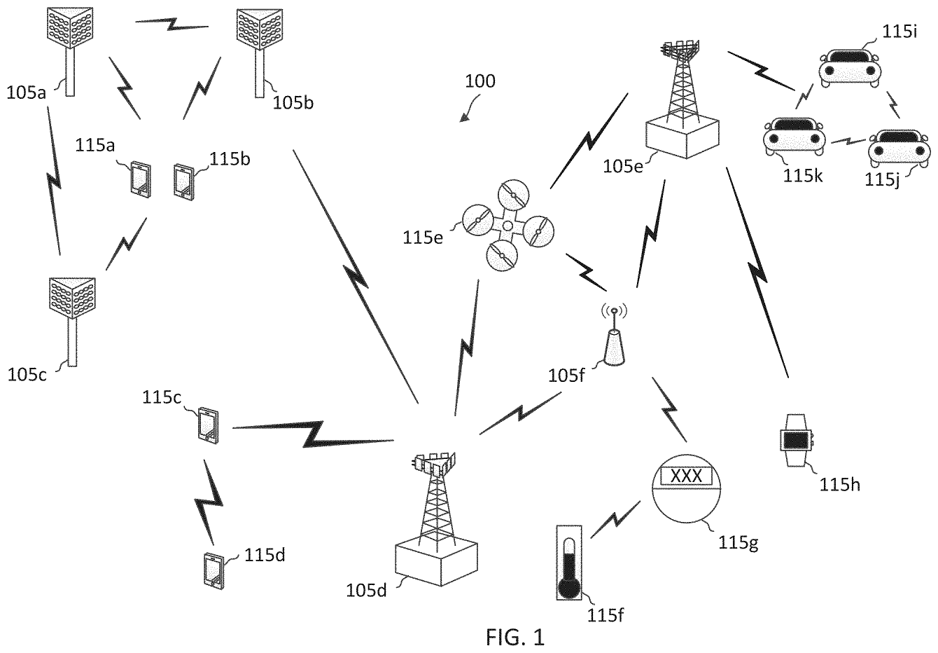

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ an LBT procedure to monitor for transmission opportunities (TXOPs) in the shared channel. A wireless communication device may perform an LBT in the shared channel. LBT is a channel access scheme that may be used in the unlicensed spectrum. When the LBT results in an LBT pass (the wireless communication device wins contention for the wireless medium), the wireless communication device may access the shared medium to transmit and/or receive data. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. Conversely, the LBT results in a failure when a channel reservation signal is detected in the channel. A TXOP may also be referred to as channel occupancy time (COT).

In some aspects, the network 100 may provision for sidelink communications to allow a UE 115 to communicate with another UE 115 without tunneling through a BS 105 and/or the core network. As discussed above, sidelink communication can be communicated over a PSCCH and a PSSCH. For instance, the PSCCH may carry SCI and the PSSCH may carry SCI and/or sidelink data (e.g., user data). Each PSCCH is associated with a corresponding PSSCH, where SCI in a PSCCH may carry reservation and/or scheduling information for sidelink data transmission in the associated PSSCH. In some examples, a sidelink transmitting UE 115 may indicate SCI in two stages. In a first-stage SCI, the UE 115 may transmit SCI in PSCCH carrying information for resource allocation and decoding a second-stage SCI. The first-stage SCI may include at least one of a priority, PSSCH resource assignment, resource reservation period (if enabled), PSSCH DMRS pattern (if more than one pattern is configured), a second-stage SCI format (e.g., size of second-stage SCI), an amount of resources for the second-stage SCI, a number of PSSCH demodulation reference signal (DMRS) port(s), a modulation and coding scheme (MCS), etc. In a second-stage SCI, the UE 115 may transmit SCI in PSSCH carrying information for decoding the PSSCH. The second-stage SCI may include an 8-bit L1 destination identifier (ID), an 8-bit L1 source ID, a HARQ process ID, a new data indicator (NDI), a redundancy version (RV), etc. It should be understood that these are examples, and the first-stage SCI and/or the second-stage SCI may include or indicate additional or different information than those examples provided. Sidelink communication can also be communicated over a physical sidelink feedback control channel (PSFCH), which indicates an acknowledgement (ACK)-negative acknowledgement (NACK) for a previously transmitted PSSCH.

In some aspects, a BS 105 may determine one or more transmission resources for sharing between a sidelink and a direct link. The sidelink may be between two UEs 115, a sidelink transmitting UE (e.g., the UE 115c) and a sidelink receiving UE (e.g., the UE 115d). The direct link may be between a BS 105 and a UE 115 (e.g., the UEs 115a or the UE 115b), which may be referred to as a direct link UE. In NR, the sidelink may be referred to as a PC5 interface and the direct link may be referred to a Uu interface. The one or more transmission resources may include DL resources that may be utilized by the BS 105 to transmit DL communications to the direct link UE 115. When the sidelink transmitting UE 115 shares a DL resource with the direct link and the sidelink transmitting UE 115 is at a close proximity to the direct link UE 115, the transmission from the sidelink transmitting UE 115 can interfere with the DL reception at the direct link UE 115.

According to aspects of the present disclosure, a BS 105 may determine one or more sidelink interference measurement resources for measuring interference from the sidelink to the direct link. In some aspects, the BS 105 may configure the sidelink transmitting UE 115 to transmit reference signals in the one or more sidelink interference measurement resources and may configure the direct link UE (to be scheduled for a DL communication with the BS 105) to measure interference from the sidelink transmitting UE 115 in the one or more sidelink interference measurement resources. The direct link UE 115 may be referred to as a direct link receiving UE for the DL communication. In some other aspects, the BS 105 may configure a direct link receiving UE 115 to transmit reference signals in the one or more sidelink interference measurement resources and configure the sidelink transmitting UE 115 to measure interference from the direct link receiving UE 115 in the one or more sidelink interference measurement resources.

In some aspects, the network 100 may utilize a centralized scheme or a decentralized scheme to manage interference from the sidelink to the direct link. In the centralized scheme, the direct link receiving UE 115 may perform sidelink interference measurement and report the interference measurement to the BS 105. The BS 105 may determine whether to mute a sidelink transmission or a direct link transmission or whether to reduce a transmission power of the sidelink transmission or a transmission power of the direct link transmission, for example, based on the amount of interference from the sidelink to the direct link, a traffic priority of the sidelink, and/or a traffic priority of the direct link.

In the decentralized scheme, when the direct link receiving UE 115 is configured to determine the interference measurement, the direct link receiving UE 115 may determine whether to request the sidelink transmitting UE 115 to mute a sidelink transmission or reduce a transmission power of the sidelink transmission based on the interference measurement and/or traffic priorities of the sidelink and direct link. Similarly, when the sidelink transmitting UE 115 is configured to determine the interference measurement, the sidelink transmitting UE 115 may determine whether to refrain from transmitting a sidelink transmission or reduce a transmission power of a sidelink transmission based on the interference measurement and/or traffic priorities of the sidelink and direct link.

The centralized interference management may provide a better priority management than the decentralized interference management as all interference handling decisions are performed by the BS 105. However, the centralized interference management may not perform well when the sidelink transmitting UE 115 is out of the coverage of the BS 105. The decentralized interference management is mainly coordinated between the sidelink transmitting UE 115 and the direct link receiving UE 115, and thus may be more suitable when the sidelink transmitting UE 115 is out of the coverage of the BS 105 or when mode 2-RRA is used for sidelink. Mechanisms for managing interference from a sidelink to a direct link are discussed in greater detail herein.

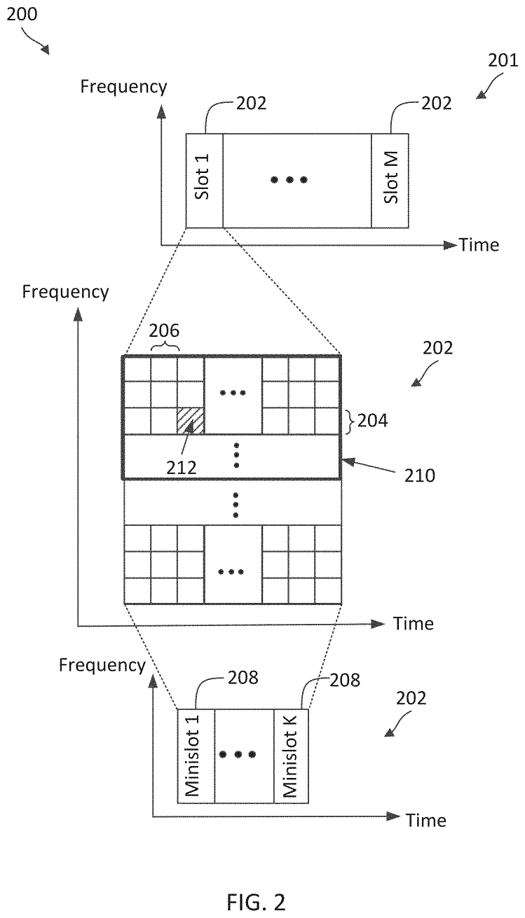

FIG. 2 illustrates a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The radio frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel BW, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS 105 may schedule a UE 115 for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204). In some aspects, the BS 105 may configure a slot format for a slot 202 and may indicate the slot format to a UE 115. For instance, the BS 105 may configure a symbol 206 in a slot 202 as a DL symbol, an UL symbol, or a flexible symbol. A DL symbol 206 may be used for a DL communication only. A UL symbol 206 may be used for an UL communication only. A flexible symbol 206 may be used for an UL communication or a DL communication.

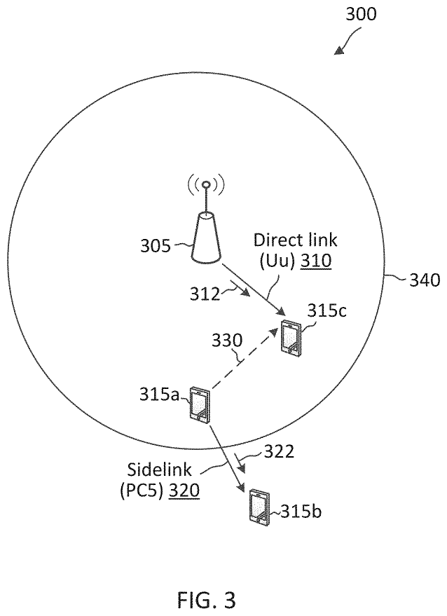

In some aspects, the BS 105 may allocate one or more transmission resources (e.g., in units of slots 202, mini-slots 208, symbols 206, RBs 210, and/or subcarriers 204) for sharing between a sidelink and a direct link. As discussed above, when a sidelink shares transmission resources with a direct link, communications over the sidelink can interfere with communications over the direct link as shown in FIG. 3.

FIG. 3 illustrates an interference scenario 300 in a wireless communication network according to some aspects of the present disclosure. The interference scenario 300 may correspond to an interference scenario in the network 100. FIG. 3 illustrates one BS 305 and two UEs 315 (shown as 315a, 315b, and 315c) for purposes of simplicity of discussion, though it will be recognized that embodiments of the present disclosure may scale to any suitable number of UEs 315 (e.g., the about 4, 5, 6, 7 or more) and/or BSs 305 (e.g., the about 2, 3 or more). The BS 305 and the UEs 315 may be similar to the BSs 105 and the UEs 115, respectively.

In the scenario 300, the UEs 315a and 315c are located within a coverage area 340 of the BS 305 and the UE 315b is located outside the coverage area 340. The BS 305 is in communication with the UE 315c over a direct link 310 (e.g., a Uu interface). The UE 315a is in communication with the UE 315b over a sidelink 320 (e.g., a PC5 interface). The BS 305 may schedule the UE 315c for a DL communication 312 over the direct link 310. The UE 315a may initiate a sidelink transmission 322 over the sidelink 320 for communication with the UE 315b. The UE 315c may be referred to as a direct link receiving UE or a Uu receiving (Rx) UE, the UE 315a may be referred to as a sidelink transmitting UE or a PC5 transmitting (Tx) UE, and the UE 315b may be referred to as a sidelink receiving UE or a PC5 Rx UE.

In some aspects, the BS 305 may allocate resources for sharing between the sidelink 320 and the direct link 310. When the sidelink transmitting UE 315a is located at an edge of the coverage area 340 and share a DL resource of the direct link 310, the sidelink transmitting UE 315a can cause interference to a DL reception in the DL resource at the direct link receiving UE 315c as shown by the dashed arrow 330. The sidelink transmitting UE 315a may be referred to as an aggressor UE and the direct link receiving UE 315c may be referred to as a victim UE.

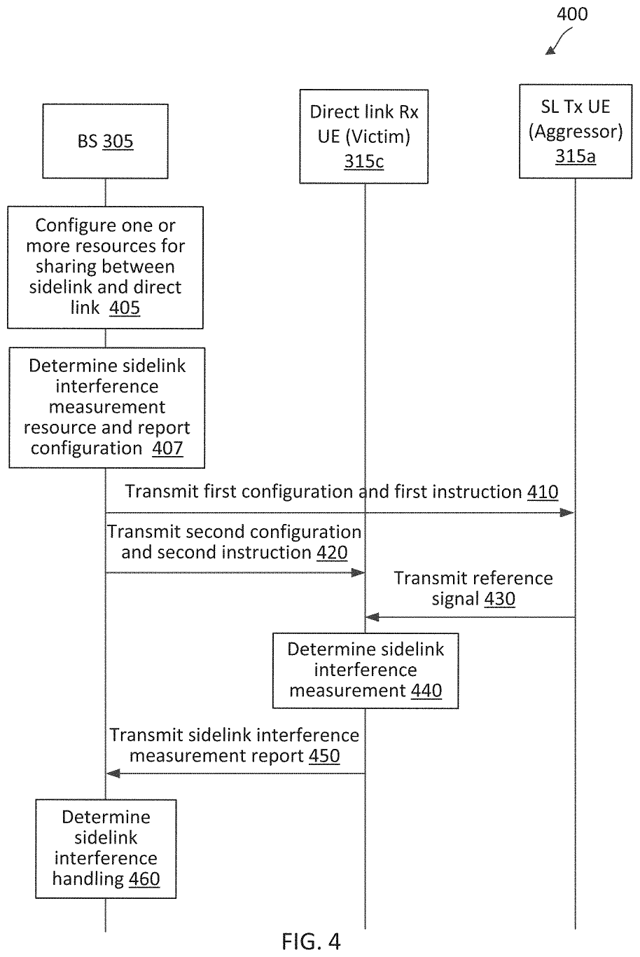

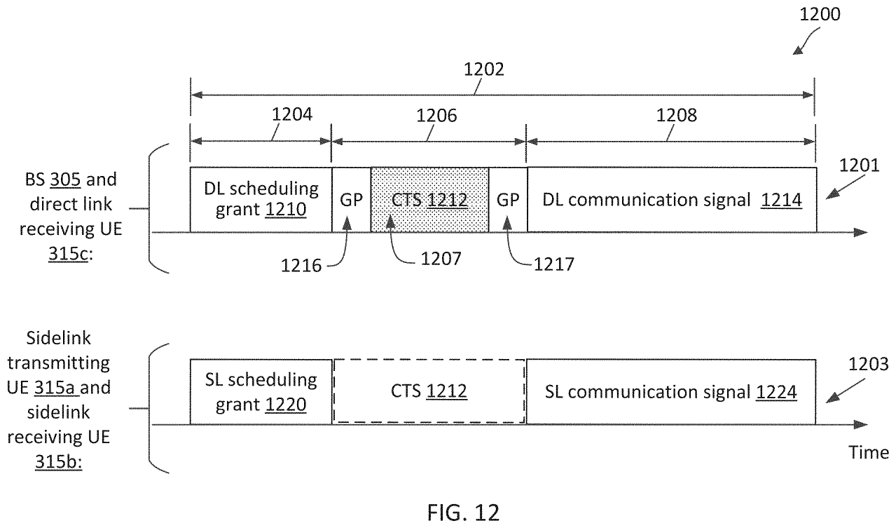

Accordingly, the present disclosure provides techniques for managing interference from a sidelink transmitting UE to a direct link receiving UE when the sidelink shares a DL transmission resource (e.g., DL symbols 206) of the direct link. FIGS. 4-10 illustrate various cross-link interference (CLI)-based mechanisms for managing interference from the sidelink to the direct link. FIGS. 11-12 illustrate various clear-to-send (CTS)-based mechanisms for managing interference from the sidelink to the direct link. The CLI-based interference management mechanisms may manage long-term sidelink interference, whereas the CTS-based interference management mechanisms may provide a more dynamic management of sidelink interference. Additionally, the CLI-based interference management mechanisms and/or the CTS-based interference management mechanisms can support centralized interference management and/or decentralized interference management as will be discussed more fully below.

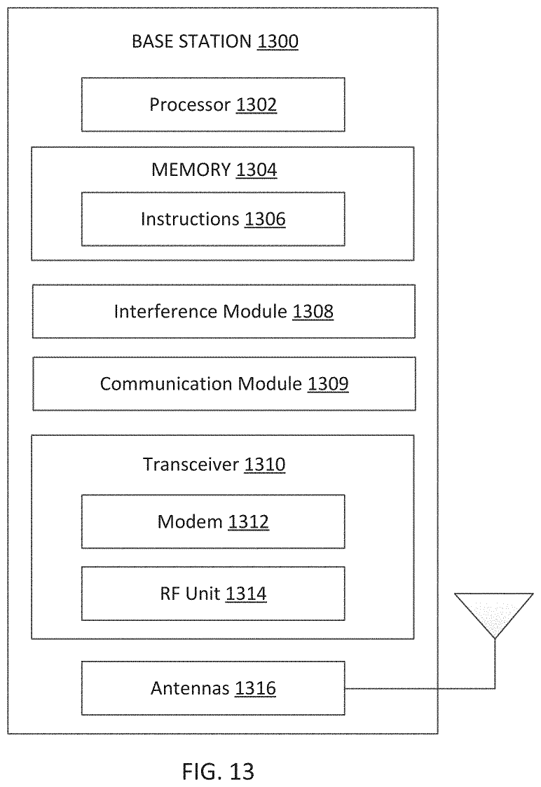

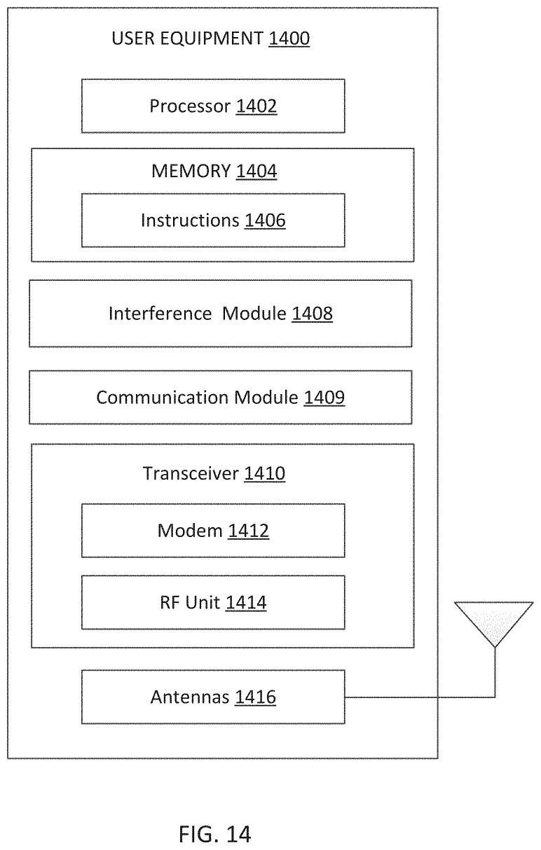

FIGS. 4-6 are discussed in relation to each other and in relation to FIG. 3 to illustrate sidelink interference management. FIG. 4 is a signaling diagram illustrating an interference management method 400 according to some aspects of the present disclosure. The method 400 may be implemented between a BS 305, a sidelink transmitting (SL Tx) UE 315a (e.g., an aggressor), and a direct link receiving (Rx) UE 315c (e.g., a victim of the interference) in the scenario 300 discussed above in relation to FIG. 3. Although FIG. 4 illustrates one BS 305, one sidelink transmitting UE 315a, and one direct link receiving UE 315c, it should be understood that in other examples method 400 can be implemented between the BS 305 and any suitable number of sidelink transmitting UEs (e.g., 2, 3, 4, 5, 6 or more) and direct link receiving UEs (e.g., 2, 3, 4, 5, 6 or more) sharing transmission resources. As illustrated, the method 400 includes a number of enumerated actions, but embodiments of the method 400 may include additional actions before, after, and in between the enumerated actions. In some aspects, one or more of the enumerated actions may be omitted or performed in a different order. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 400.

At action 405, the BS 305 configures one or more transmission resources for sharing between a sidelink and a direct link. The sidelink may correspond to the sidelink 320 between the sidelink transmitting UE 315a and the sidelink receiving UE 315b shown in FIG. 3. The direct link may correspond to the direct link 310 between the BS 305 and the direct link receiving UE 315c shown in FIG. 3. The one or more transmission resources are time-frequency resources, which may be in the form of symbols 206, mini-slots 208, and/or RBs 210 as in the radio frame structure 200 discussed above in relation to FIG. 2. The one or more transmission resources may include one or more DL resources (e.g., DL symbols 206). In some aspects, the BS 305 may configure a sidelink resource pool including the one or more DL resources and may configure the sidelink transmitting UE 315a with the sidelink resource pool. In some aspects, the BS 305 may configure the sidelink transmitting UE 315a with a configured grant indicating sidelink resources for the sidelink transmitting UE 315a to transmit sidelink transmission, and the configured sidelink resources may include the DL resources.

At action 407, the BS 305 determines a sidelink interference measurement resource and report configuration. For instance, the BS 305 may determine one or more sidelink interference measurement resources for determining an interference from the sidelink to the direct link. The one or more sidelink interference measurement resources are time-frequency resources, which may be in the form of symbols 206, mini-slots 208, and/or RBs 210 as in the radio frame structure 200 discussed above in relation to FIG. 2. In some instances, the one or more sidelink interference measurement resources may be recurring at a certain periodicity. For instance, a sidelink interference measurement resource may be allocated at symbol 206 K of slot 202 N in every M radio frames 201, where K, N, and M are positive integers. The sidelink interference measurement resource may span any suitable BW and/or any suitable periodicity, which may or may not correspond to a BW and/or a periodicity of the sidelink and/or downlink transmissions in the shared transmission resource. In some aspects, the BS 305 may determine a BW and/or a periodicity of a sidelink interference measurement resource based on a channel condition. In some aspects, the BS 305 may allocate the one or more sidelink interference measurement resources based on the one or more transmission resources being shared by the direct link and the sidelink.

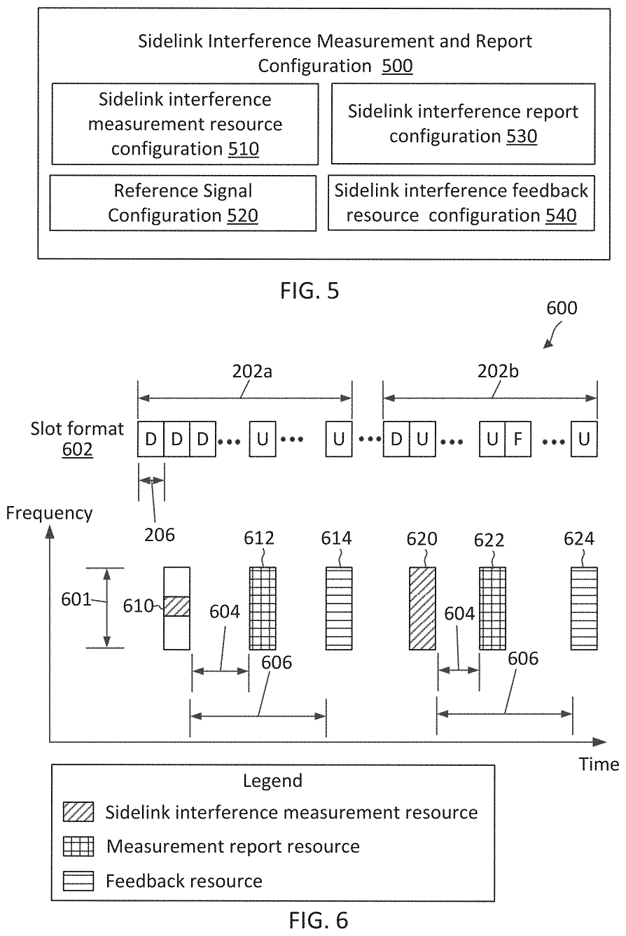

In some aspects, the BS 305 may determine that the sidelink transmitting UE 315a is an interference source to the direct link receiving UE 315c. Accordingly, the BS 305 may configure the sidelink transmitting UE 315a to transmit a reference signal in the one or more sidelink interference measurement resources and configure the direct link receiving UE 315c to measure interference from the one or more sidelink interference measurement resources. The BS 305 may also determine the type of reference signal to be transmitted in each sidelink interference measurement resource and/or the type of measurement report to be determined from each sidelink interference measurement resource, for example, based on the type of interference information the BS 305 desires and/or the channel conditions. In some instances, the BS 305 may also assign different traffic sidelink priorities to different sidelink interference measurement resources. For instance, the BS 305 may assign a high priority or a low priority to a sidelink interference measurement resource. Thus, the sidelink transmitting UE 315a may select a sidelink interference measurement resource corresponding to a traffic priority of a sidelink transmission to be transmitted over the sidelink using one of the DL resources. In some instances, the BS 305 may also allocate one or more resources for the direct link receiving UE 315c to transmit a measurement report. In some instances, the BS 305 may also allocate one or more resources where the BS 305 or the direct link receiving UE 315c may transmit an interference feedback indication to the sidelink transmitting UE 315a. The BS 305 may include various information related to sidelink interference measurement resource and/or reporting in a configuration as will be discussed in FIG. 5 below.

FIG. 5 illustrates an exemplary sidelink interference measurement and report configuration 500 according to some aspects of the present disclosure. The configuration 500 corresponds to the sidelink interference measurement and report configuration determined by the BS 305 at action 407. The configuration 500 includes an sidelink interference measurement resource configuration 510, a reference signal configuration 520, a report configuration 530, and a sidelink interference feedback resource configuration 540.

The sidelink interference measurement resource configuration 510 may indicate the allocations of the one or more sidelink interference measurement resources. For example, the sidelink interference measurement resource configuration 510 may indicate a time and/or frequency location for each sidelink interference measurement resource, for example, in the form of symbols 206, mini-slots 208, and/or RBs 210 as in the radio frame structure 200 discussed above in relation to FIG. 2 and discussed further below in relation to FIG. 6. The one or more sidelink interference measurement resource may have a certain BW or a certain SCS. The BW and SCS of the one or more sidelink interference measurement resource may be preconfigured and known to the sidelink transmitting UE 315a and the direct link receiving UE 315c. Alternatively, the sidelink interference measurement resource configuration 510 may indicate the BW and SCS of the one or more sidelink interference measurement resources.

The reference signal configuration 520 may indicate a reference signal type (the type of reference signal to be transmitted) for each sidelink interference measurement resource for interference measurement. For instance, the BS 305 may indicate in the reference signal configuration 520 whether the sidelink transmitting UE 315a is to transmit a wideband reference signal or a narrowband signal in a certain sidelink interference measurement resource as will be discussed more fully below in relation to FIG. 6. A wideband reference signal may provide better or more accurate interference information, whereas a narrowband reference signal may provide less interference information.

In some aspects, the BS 305 may indicate in the reference signal configuration 520 that a wideband SRS is to be transmitted in a certain sidelink interference measurement resource. An SRS is a physical waveform signal, for example, a certain signal sequence. In some instances, the BS 305 may assign the sidelink transmitting UE 315a with a certain SRS waveform sequence, which may be used as a signature to identify the sidelink transmitting UE 315a. For instance, the BS 305 may assign different sidelink transmitting UEs with different SRS waveform sequences and may configure different sidelink transmitting UEs to transmit in different sidelink interference measurement resources. For example, the BS 305 may assign a first SRS waveform sequence to the sidelink transmitting UE 315a for transmission in a first sidelink interference measurement resource of the one or more sidelink interference measurement resources. The BS 305 may assign a second SRS waveform sequence to another sidelink transmitting UE for transmission in a second sidelink interference measurement resource of the one or more sidelink interference measurement resources. The first SRS waveform sequence is different from the second SRS waveform sequence. The first sidelink interference measurement resource is different from the second sidelink interference measurement resource. The SRS waveform sequences may also be indicated to the direct link receiving UE 315c. As such, the direct link receiving UE 315c can determine the interference source (e.g., UE that transmitted the reference signal) for a measurement determined from a particular sidelink interference measurement resource based on the detected SRS waveform sequence.

In some aspects, the BS 305 may indicate in the reference signal configuration 520 that a wideband CSI-RS is to be transmitted in a certain sidelink interference measurement resource. A CSI-RS is physical waveform sequence that may be used for estimating channel state information (e.g., channel delay spread, Dopplers, spatial information, channel responses, and/or the like).

In some aspects, the BS 305 may indicate in the reference signal configuration 520 that a narrowband DMRS is to be transmitted in a certain sidelink interference measurement resource. A DMRS may include a sequence of pilot symbols that may be used by a receiver to determine a channel response for demodulation and data decoding at the receiver.

In some aspects, the BS 305 may indicate in the reference signal configuration 520 that a narrowband sidelink synchronization signal is to be transmitted in a certain sidelink interference measurement resource. A sidelink synchronization signal may include a sidelink SSB similar to an SSB broadcast by a BS. The sidelink SSB can include physical synchronization signals similar to the PSS and/or SSS. The sidelink SSB can include a physical sidelink broadcast channel (PSBCH) signal similar to a PBCH signal. The PSBCH signal may include system information related communications over sidelink. In some examples, the reference signal configuration 520 may indicate a regular sidelink synchronization signal including one or more physical synchronization signals and a PBCH signal. In some examples, the reference signal configuration 520 may indicate a lite-version of the sidelink synchronization signal, for example, including a physical synchronization signal without a PBCH signal.

The sidelink interference report configuration 530 may indicate a measurement report type (the type of measure report to be transmitted for interference measured) for each sidelink interference measurement resource. For instance, the BS 305 may indicate in the sidelink interference report configuration 530 whether the direct link receiving UE 315c is to report a RSRP or a RSSI for a certain sidelink interference measurement resource. In some aspects, the BS 305 may also indicate in the sidelink interference report configuration 530 one or more resources allocated for the direct link receiving UE 315c to transmit an interference measurement report (e.g., the RSRP and/or RSSI) to the BS 305 as will be discussed more fully below in relation to FIG. 6.

In some aspects, the BS 305 may additionally indicate in the sidelink interference measurement resource configuration 510 a sidelink traffic priority for each sidelink interference measurement resource. For instance, the BS 305 may assign different sidelink traffic priorities to different sidelink interference measurement resources. For example, the BS 305 may assign a first sidelink traffic priority to a first sidelink interference measurement resource of the one or more sidelink interference measurement resources. The BS 305 may assign a second sidelink traffic priority to a second sidelink interference measurement resource of the one or more sidelink interference measurement resources. The first sidelink traffic priority may be higher than the second sidelink traffic priority. The first sidelink interference measurement resource is different from the second sidelink interference measurement resource. As such, the direct link receiving UE 315c can determine the sidelink traffic priority of the interference source (e.g., UE that transmitted the reference signal) for a sidelink interference measurement resource based on the sidelink traffic priority of the sidelink interference measurement resource. In some aspects, the BS 305 may indicate in the sidelink interference report configuration 530 a request for reporting a sidelink traffic priority associated with the interference.

The sidelink interference feedback resource configuration 540 may indicate one or more resources where the BS 305 and/or the direct link receiving UE 315c may transmit an interference feedback indication to the sidelink transmitting UE 315a.

Returning to FIG. 4, at action 410, the BS 305 transmits a first configuration and a first instruction to the sidelink transmitting UE 315a. The first configuration may include the configuration 500. The first instruction may instruct the sidelink transmitting UE 315a to transmit a reference signal in the one or more sidelink interference measurement resources as indicated by the first configuration. The BS 305 may transmit the first instruction to the sidelink transmitting UE 315a based on the sidelink transmitting UE 315a causing the interference. In some instances, the first instruction may be part of the first configuration. For instance, the first configuration may be an RRC configuration and may include the first instruction enabling or disabling a reference signal transmission in a certain sidelink interference measurement resource. In some other instances, the first instruction may be a trigger separate from the first configuration. For instance, the first configuration may be an RRC configuration and the first instruction may be a separate RRC configuration or indicated in PDCCH DCI.

At action 420, the BS 305 transmits a second configuration and a second instruction to the direct link receiving UE 315c. The second configuration may include the configuration 500. The second instruction may instruct the direct link receiving UE 315c to measure an interference in the one or more sidelink interference measurement resources as indicated by the second configuration. In some instances, the second instruction may be part of the second configuration. For instance, the second configuration may be an RRC configuration and may include the second instruction enabling or disabling an interference report for a certain sidelink interference measurement resource. In some other instances, the second instruction may be a trigger separate from the second configuration. For instance, the second configuration may be an RRC configuration and the second instruction may be a separate RRC configuration or indicated in PDCCH DCI.

At action 430, the sidelink transmitting UE 315a transmits a reference signal in an sidelink interference measurement resource as configured by the first sidelink interference measurement resource and configuration and the first instruction. As an example, the first instruction may instruct the sidelink transmitting UE 315a to transmit a reference signal in a first sidelink interference measurement resource of the one or more sidelink interference measurement resources. Depending on the reference signal type indicated by the first configuration, the sidelink transmitting UE 315a may transmit an SRS (based on an SRS waveform sequence assigned to the sidelink transmitting UE 315a), a CSI-RS, a DMRS, or a sidelink synchronization signal in the first sidelink interference measurement resource.

In another example, the first instruction may instruct the sidelink transmitting UE 315a to select a sidelink interference measurement resource from the one or more sidelink interference measurement resources based on a traffic priority of a transmission to be transmitted by the sidelink transmitting UE 315a over the sidelink. Accordingly, the sidelink transmitting UE 315a may select a sidelink interference measurement resource from the one or more sidelink interference measurement resources based on a sidelink traffic priority of a transmission to be transmitted by the sidelink transmitting UE 315a. For instance, a first sidelink interference measurement resource of the sidelink interference measurement resources may be assigned for a high sidelink traffic priority and a second sidelink interference measurement resource of the one or more sidelink interference measurement resources may be assigned for a low sidelink traffic priority. Thus, if the sidelink transmitting UE 315a is to transmit a sidelink transmission with a high sidelink traffic priority (in a DL resource of the direct link 310), the sidelink transmitting UE 315a may transmit the reference signal in the first sidelink interference measurement resource. However, if the sidelink transmitting UE 315a is to transmit a sidelink transmission with a low sidelink traffic priority (in a DL resource of the direct link 310), the sidelink transmitting UE 315a may transmit the reference signal in the second sidelink interference measurement resource.

In some aspects, the sidelink transmitting UE 315a may transmit the reference signal in the first sidelink interference measurement resource regardless of whether the sidelink transmitting UE 315a has data traffic available or ready for transmission over the sidelink and/or a traffic priority of the sidelink. In some other aspects, the sidelink transmitting UE 315a may transmit the reference signal based on the sidelink transmitting UE 315a has data ready for transmission over the sidelink. In other words, the sidelink transmitting UE 315a may not transmit the reference signal if the sidelink transmitting UE 315a does not have data for transmission over the sidelink. In some aspects, the BS 305 may configure the sidelink transmitting UE 315a to transmit a reference signal in a specific SRS resource and/or utilize a specific root sequence (e.g., waveform sequence) for the reference signal when the traffic priority of the sidelink is high. In some aspects, when the sidelink priority is high, the sidelink transmitting UE 315a may omit the transmission of the reference signal, for example, to save power at the UE 315a.

At action 440, the direct link receiving UE 315c determines a sidelink interference measurement as configured by the second sidelink interference measurement resource and configuration and the second instruction. As an example, the second configuration and the second instruction may instruct the direct link receiving UE 315c to report an interference measurement for each sidelink interference measurement resource. Depending on the report type indicated by the second configuration, the direct link receiving UE 315c may compute an RSRP or an RSSI for a reference signal received in sidelink interference measurement resource. For instance, to compute an RSRP for the first sidelink interference measurement resource, the direct link receiving UE 315c may perform a signal detection for a particular reference signal (e.g., an SRS or a CSI-RS as indicated by the second configuration) in the first sidelink interference measurement resource and compute the RSRP upon detecting the particular reference signal. In some instances, the signal detection may include computing a correlation value between a received signal and a sequence of the particular reference signal. The particular signal is detected if the correlation value satisfies a threshold. Since RSRP includes the detection of a particular signal or waveform, the use of RSRP for measurement may allow the direct link receiving UE 315c to determine which node is the source of the interference. To compute an RSSI, the direct link receiving UE 315c may compute the RSSI based on a signal received from the first sidelink interference measurement resource. Since there is no detection of a particular signal in RSSI, the direct link receiving UE 315c may not identify the interference source. In general, RSSI measurements may have a lower implementation complexity than RSRP measurements, but RSRP measurements may provide more information or a more complete profile of the interference. In some aspects, the direct link receiving UE 315c may also determine a sidelink traffic priority associated with the interference (e.g., the reference signal) based on a priority associated with a sidelink interference measurement resource in which the reference signal is received and measured.

In some aspects, the direct link receiving UE 315c may also determine a beam direction or spatial direction in which the reference signal is received, for example, based on a receive beam direction used by the direct link receiving UE 315c to receive the reference signal. In some aspects, the direct link receiving UE 315c may also identify the sidelink transmitting UE 315a that transmitted the reference signal in the first sidelink interference measurement resource based on the content (e.g., the waveform sequence) of the reference signal. As discussed above, the BS 305 may assign the sidelink transmitting UE 315a with a certain SRS waveform sequence, and thus the direct link receiving UE 315c may identify a transmitter of the reference signal based on the waveform sequence of the received reference signal. In some aspects, the direct link receiving UE 315c may be configured with information associated with an identifier (ID) of the sidelink transmitting UE 315a and the SRS waveform sequence assigned to the sidelink transmitting UE 315a, and thus the direct link receiving UE 315c may determine the ID of the transmitter based on the waveform sequence of the received reference signal.

At action 450, the direct link receiving UE 315c transmits a sidelink interference measurement report to the BS 305. The report may indicate an RSRP or an RSSI, for example, determined from the reference signal received in the first sidelink interference measurement resource. The report may also indicate a sidelink traffic priority and/or interference directional information determined from the reference signal received in the first sidelink interference measurement resource. The report may further indicate an ID of the interfering transmitter (e.g., the sidelink transmitting UE 315a) determined from the waveform sequence of the reference signal received in the first sidelink interference measurement resource.

In some aspects, the one or more sidelink interference measurement resources may include multiple sidelink interference measurement resources configured for a group of sidelink transmitting UEs including the sidelink transmitting UE 315a. Each sidelink transmitting UE in the group of sidelink transmitting UEs may transmit a reference signal in a corresponding sidelink interference measurement resource configured for the sidelink transmitting UE. Thus, the direct link receiving UE 315c may determine an interference measurement for each sidelink transmitting UE in the group of sidelink transmitting UEs. For instance, the direct link receiving UE 315c may determine a first interference measurement in a first sidelink interference measurement resource configured for a first sidelink transmitting UE in the group. The direct link receiving UE 315c may determine a second interference measurement in a second sidelink interference measurement resource configured for as a second sidelink transmitting UE in the group. The direct link receiving UE 315c may transmit the measurement report including multiple interference measurements for the group of sidelink transmitting UEs.

In some aspects, the direct link receiving UE 315c may transmit the report in a resource indicated by the BS 305. For instance, the second configuration may indicate a resource for reporting an interference as discussed above in relation to FIG. 5. Alternatively, the direct link receiving UE 315c may be preconfigured with a resource offset from a sidelink interference measurement resource for reporting an interference measurement determined from the sidelink interference measurement resource as will be discussed more fully below in relation to FIG. 6. In some other aspects, the direct link receiving UE 315c may wait for an indication or a trigger from the BS 305 and respond to the trigger by transmitting the measurement report. For instance, the BS 305 may transmit DCI requesting for the measurement report and may additionally indicate a resource for transmitting the measurement report in the DCI.

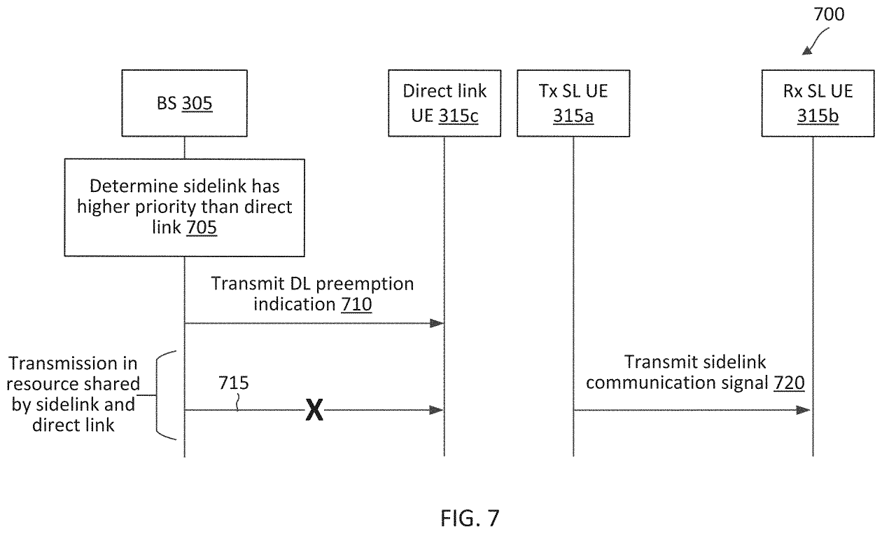

At action 460, upon receiving the sidelink interference measurement report, the BS 305 determines sidelink interference handling based on the received report. The BS 305 may handle the sidelink interference in a variety of ways. For instance, the BS 305 may determine whether to mute (or cancel) a sidelink transmission over the sidelink or a direct link transmission or whether to reduce a transmission power of the sidelink transmission or a transmission power of the direct link transmission, for example, based on the reported amount of interference and/or the traffic priority of the sidelink and/or a traffic priority of the direct link as will be discussed more fully below in relation to FIGS. 7-10.

As discussed above, the sidelink transmitting UE 315a may transmit various types of reference signals to facilitate interference measurements. Some reference signals may also provide other channel information in addition to inference measurements. For instance, when the sidelink transmitting UE 315a transmits a wideband SRS as the reference signal, the direct link receiving UE 315c may also determine CSI (e.g., a channel response and/or channel spatial information) associated with the channel (e.g., the interference path) between direct link receiving UE 315c and the sidelink transmitting UE 315a from the wideband SRS. Additionally or alternatively, the BS 305 may determine CSI (e.g., a channel response and/or channel spatial information) associated with the channel (e.g., the interference path) between the direct link receiving UE 315c and the sidelink transmitting UE 315a based on the measurement report received from the direct link receiving UE 315c. Additionally or alternatively, a sidelink receiving UE (e.g., the sidelink receiving UE 315b) of the sidelink may also monitor for the wideband SRS and determine CSI associated with the sidelink from the wideband SRS. Alternatively, when the sidelink transmitting UE 315a transmits a sidelink synchronization signal as the reference signal, the BS 305 may configure the direct link receiving UE 315c to monitor for the sidelink synchronization signal. In other words, the direct link receiving UE 315c may monitor for sidelink synchronization signal even though the direct link receiving UE 315c is not participating in a sidelink communication.

FIG. 6 illustrates a sidelink interference measurement and report scheme 600 according to some aspects of the present disclosure. The scheme 600 may be employed by a BS such as the BSs 105 and/or the BS 305 and a UE such as the UEs 115 and/or 315 for sidelink interference measurement and reporting. In FIG. 6, the x-axis represents time in some arbitrary units, and the y-axis represents frequency in some arbitrary units. The scheme 600 may be implemented in conjunction with the method 400 and/or the configuration 500 discussed above in relation to FIGS. 4 and/or 5, respectively.

For instance, the BS 305 allocates a plurality of sidelink interference measurement resources 610 and 620 in a frequency band 601. The frequency band 601 may correspond to a communication frequency bandwidth between the BS 305 and the direct link receiving UE 315c over the direct link 310 of FIG. 3 and/or the communication frequency bandwidth between the sidelink transmitting UE 315a and the sidelink receiving UE 315b over the sidelink 320 of FIG. 3. The sidelink interference measurement resource 610 may be located in a slot 202a and the sidelink interference measurement resource 620 may be in located in a slot 202b. The slots 202a and 202b may be spaced apart by one or more other slots 202 as shown. Alternatively, the slots 202a and 202b may be consecutive slots 202 in time. Each of the slot 202a and slot 202b may include a plurality of symbols 206 the BS 105 may configure a slot format 602 for each slot 202 and may indicate the slot format 602 to a UE 115.

The BS 305 may configure each symbol 206 in a slot 202 to be a DL symbol (shown by the letter “D”), an UL symbol (shown by the letter “U”), or a flexible symbol (shown by the letter “F”). A DL symbol 206 may be used for a DL communication only. A UL symbol 206 may be used for an UL communication only. A flexible symbol 206 may be used for an UL communication or a DL communication. The BS 305 may configure a sidelink interference measurement resource in a DL symbol or an UL symbol. As shown, the sidelink interference measurement resource 610 is in a DL symbol and the sidelink interference measurement resource 620 is in an UL symbol. When a sidelink interference measurement resource (e.g., the resource 610) is configured in a DL symbol, the BS 305 may refrain from transmitting a DL communication in the sidelink interference measurement resource to allow for a more accurate interference measurement at the direct link receiving UE 315c. For instance, if a DL communication signal is scheduled to transmit in a resource that is at least partially overlapping with the sidelink interference measurement resource, the BS 305 may rate-match around the sidelink interference measurement resource 610. Rate-match may refer to extracting the exact set of bits or number of bits to be transmitted within a given transmission time interval (e.g., excluding the resource 610). When a sidelink interference measurement resource (e.g., the resource 620) is configured in an UL symbol, the BS 305 may refrain from scheduling a PUSCH in the UL symbol to allow for better detectability of the interference at the direct link receiving UE 315c. For instance, the BS 305 may not consider the UL symbol where the sidelink interference measurement resource is located during UL scheduling. In some instances, it may be more desirable to configure a sidelink interference measurement resource in a DL symbol than in an UL symbol in order to avoid timing advance issues or mismatch between a reference signal transmission from the sidelink transmitting UE 315a and an UL transmission from a direct link UE.

The BS 305 may configure a sidelink interference measurement resource to span a full BW of the frequency band 601 or a portion of the BW of the frequency band 601. As shown, the sidelink interference measurement resource 610 spans a portion of BW of the frequency band 601, and the sidelink interference measurement resource 620 spans a full bandwidth of the frequency band 601. The sidelink interference measurement resource 610 may be configured for a narrowband reference signal transmission (e.g., a DMRS or a sidelink synchronization signal). The sidelink interference measurement resource 620 may be configured for a wideband reference signal transmission (e.g., an SRS or a CSI-RS). The BS 305 may configure the sidelink interference measurement resources 610 and 620 to be periodic. The BS 305 may determine the BW and/or the periodicity of the sidelink interference measurement resources based on channel conditions, traffic loads of the direct link, traffic loads of the sidelink, and/or the level of interference information that the BS 305 desires. For instance, the BS 305 may allocate a sidelink interference measurement resource in a wideband (e.g., a full BW of the frequency band 601) for a more complete view of the interference. The BS 305 may allocate a sidelink interference measurement resource in a narrowband (e.g., a portion of the BW of the frequency band 601) for a lower interference measurement complexity. The BS 305 may allocate a sidelink interference measurement resource with a higher periodicity if the channel conditions vary rapidly and/or if the traffic load is high over the sidelink and/or the direct link.

In some aspects, the BS 305 may assign a sidelink traffic priority for each sidelink interference measurement resource 610 and 620. For instance, the BS 305 may assign a first sidelink traffic priority to the sidelink interference measurement resource 610 and a second sidelink traffic priority to the sidelink interference measurement resource 620. The first sidelink traffic priority may correspond to a high traffic priority, and the second sidelink traffic priority may correspond to a low traffic priority. Accordingly, the sidelink transmitting UE 315a may select the sidelink interference measurement resource 610 if the sidelink transmitting UE 315 is to transmit a sidelink transmission with a high traffic priority (in a DL resource of the direct link 310). Conversely, the sidelink transmitting UE 315a may select the sidelink interference measurement resource 620 if the sidelink transmitting UE 315 is to transmit a sidelink transmission with a low traffic priority (in a DL resource of the direct link 310).

In some aspects, the BS 305 may additionally allocate a plurality of measurement report resources 612 and 622. For instance, the measurement report resource 612 may be used for transmitting an interference measurement determined from the sidelink interference measurement resource 610. The measurement report resource 622 may be used for transmitting an interference measurement determined from the sidelink interference measurement resource 620. In some instances, the BS 305 may configure a measurement report resource for each sidelink interference measurement resource and may indicate the measurement report resource (e.g., in the sidelink interference report configuration 530) in association with each sidelink interference measurement resource. In some aspects, the measurement report resource 612 may be offset from the corresponding sidelink interference measurement resource 610 based on a preconfigured offset 604 (e.g., 1 slot, 2 slots, 3 slots or more). Similarly, the measurement report resource 622 may be offset from the corresponding sidelink interference measurement resource 620 based on the preconfigured offset 604.

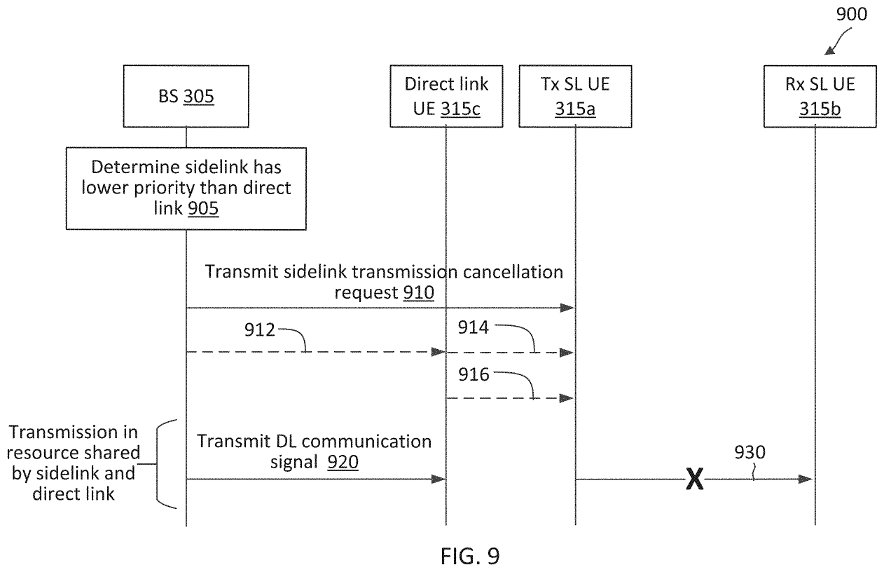

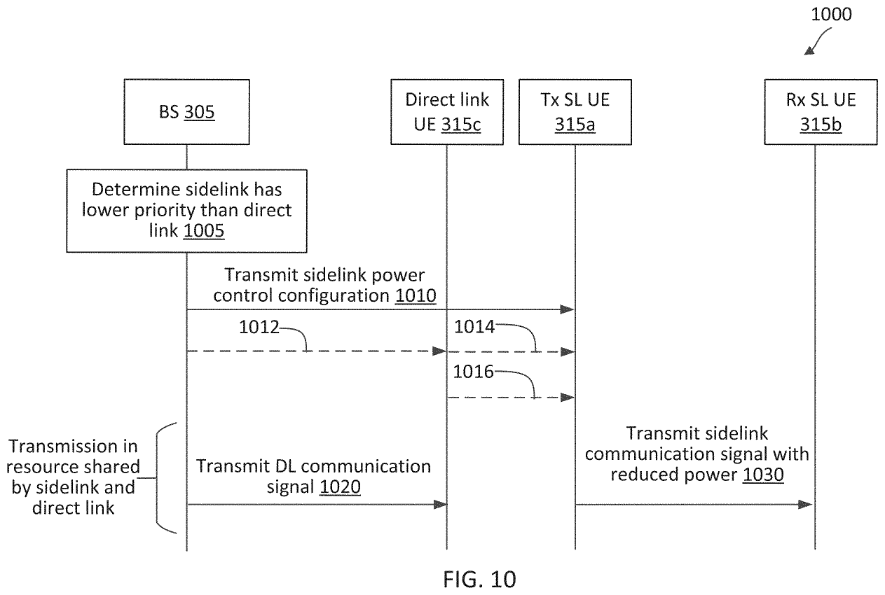

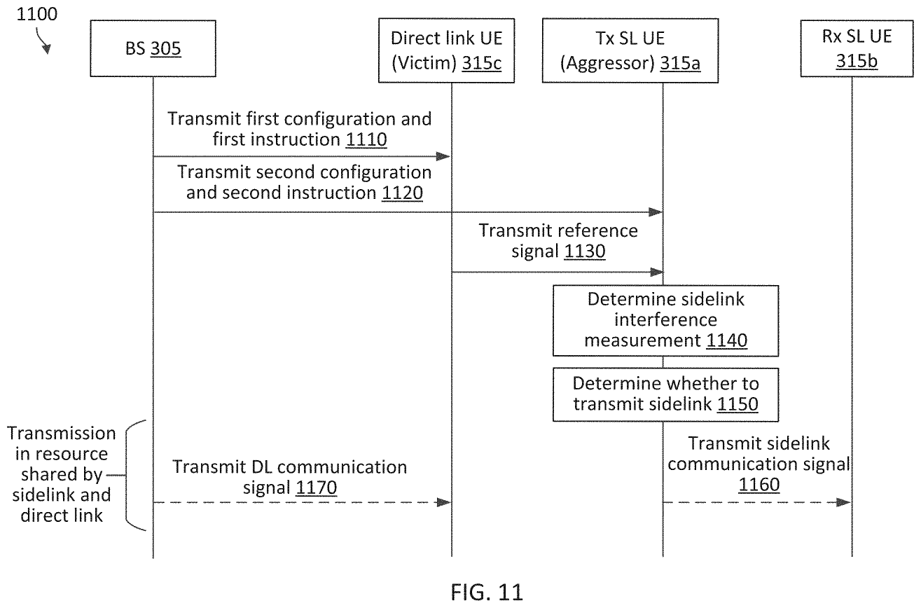

In some aspects, the BS 305 may additionally allocate a plurality of feedback indication resources 614 and 624. For instance, the feedback indication resource 614 may be used for transmitting an interference feedback indication based on a measurement determined from the sidelink interference measurement resource 610. The feedback indication resource 624 may be used for transmitting interference feedback indication based on a measurement determined from the sidelink interference measurement resource 620. Interference feedback indications may be transmitted by the BS 305 or the direct link receiving UE 315c to the sidelink transmitting UE 31a as will be discussed more fully below in relation to FIGS. 9 and 10. In some instances, the BS 305 may configure a feedback indication resource for each sidelink interference measurement resource and may indicate the feedback indication resource (e.g., in the sidelink interference feedback resource configuration 540) in association with each sidelink interference measurement resource. In some aspects, the feedback indication resource 614 may be offset from the corresponding sidelink interference measurement resource 610 based on a preconfigured offset 606 (e.g., 1 slot, 2 slots, 3 slots or more). Similarly, the feedback indication resource 624 may be offset from the corresponding sidelink interference measurement resource 620 based on the preconfigured offset 606.

While FIG. 6 illustrates each sidelink interference measurement resource 610, 620, each measurement report resources 612, 622, and each feedback resource 614, 624 occupying one symbol 206, it should be understood that in other examples each sidelink interference measurement resource 610, 620, each measurement report resources 612, 622, and each feedback resource 614, 624 may occupy any suitable number of symbols 206 (e.g., 2 or 3) and/or any portion of the frequency band 601.

FIG. 7 is a signaling diagram illustrating an interference management method 700 according to some aspects of the present disclosure. The method 700 may be implemented among the BS 305, the sidelink transmitting (SL Tx) UE 315a, the sidelink receiving (Rx) UE 315b, and the direct link receiving (Rx) UE 315c in the scenario 300 discussed above in relation to FIG. 3. Although FIG. 7 illustrates one BS 305, one sidelink transmitting UE 315a, one sidelink receiving UE 315b, and one direct link receiving UE 315c, it should be understood that in other examples method 700 can be implemented among the BS 305 and any suitable number of sidelink transmitting UEs (e.g., 2, 3, 4, 5, 6 or more), any suitable number of sidelink receiving UE (e.g., 2, 3, 4, 5, 6, or more), and any suitable number of direct link receiving UEs (e.g., 2, 3, 4, 5, 6 or more) sharing transmission resources. As illustrated, the method 700 includes a number of enumerated actions, but embodiments of the method 700 may include additional actions before, after, and in between the enumerated actions. In some embodiments, one or more of the enumerated actions may be omitted or performed in a different order. The method 700 may be implemented in conjunction with the method 400, the configuration 500, and/or the scheme 600 discussed above in relation to FIGS. 4, 5, and/or 6, respectively. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a, the sidelink receiving UE 315b, and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 700.

At action 705, the BS 305 determines the sidelink (e.g., the sidelink 320) associated with the sidelink transmitting UE 315a has a higher priority than the direct link (e.g., the direct link 310) of the BS 305, for example, based on a sidelink traffic priority indicated by the measurement report received from the direct link receiving UE 315c as discussed above in method 400. For instance, the BS 305 may perform action 705 as part of action 460 of the method 400 of FIG. 4.

In some aspects, the BS 305 may have transmitted a scheduling grant to the direct link receiving UE 315c for communicating a DL communication signal using a DL resource shared by the sidelink. Thus, at action 710, in response to determining the sidelink has a higher traffic priority than the direct link, the BS 305 transmits a DL preemption indication or a DL transmission cancellation indication to the direct link receiving UE 315c to cancel a transmission of the scheduled DL communication signal. In some aspects, the BS 305 may not transmit the DL preemption indication and proceed to action 715.

At action 715, in response to determining the sidelink has a higher traffic priority than the direct link, the BS 305 refrains from transmitting a DL communication signal to the direct link receiving UE 315c using a resource (e.g., a DL resource) shared by the sidelink and the direct link as indicated by the symbol “X”. For instance, the measurement report may indicate a high interference measurement, and thus a DL transmission to the direct link receiving UE 315c can potentially cause a higher interference to the high-priority sidelink transmission. The BS 305 may refrain from transmitting the DL communication signal by cancelling or postponing a DL transmission schedule, and/or or removing a prepared transport block associated with the DL communication from a transmission queue.

At action 720, the sidelink transmitting UE 315a transmits a sidelink communication signal (e.g., SCI or sidelink data) to the sidelink receiving UE 315b over the sidelink using the resource shared by the sidelink and the direct link. For instance, the sidelink transmitting UE 315a may monitor for an interference feedback indicator (e.g., in the feedback resources 614 and/or 624) and may transmit the sidelink communication signal based on no interference feedback indication being received. In some aspects, when the sidelink has a high traffic priority, the sidelink transmitting UE 315a may transmit the sidelink transmission without monitoring for an interference feedback indication.

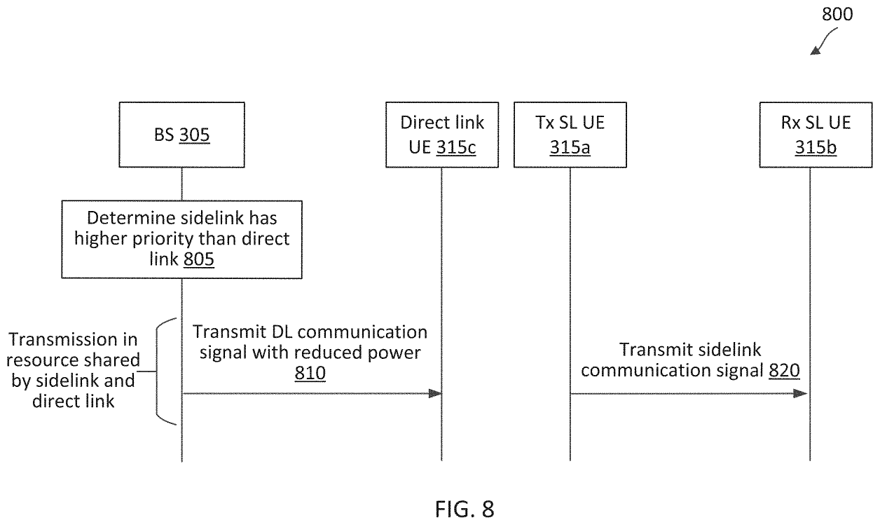

FIG. 8 is a signaling diagram illustrating an interference management method 800 according to some aspects of the present disclosure. The method 800 may be implemented among the BS 305, the sidelink transmitting (SL Tx) UE 315a, the sidelink receiving (Rx) UE 315b, and the direct link receiving (Rx) UE 315c in the scenario 300 discussed above in relation to FIG. 3. Although FIG. 8 illustrates one BS 305, one sidelink transmitting UE 315a, one sidelink receiving UE 315b, and one direct link receiving UE 315c, it should be understood that in other examples method 800 can be implemented between the BS 305 and any suitable number of sidelink transmitting UEs (e.g., 2, 3, 4, 5, 6 or more), any suitable number of sidelink receiving UE (e.g., 2, 3, 4, 5, 6, or more), any suitable number of direct link receiving UEs (e.g., 2, 3, 4, 5, 6 or more) sharing transmission resources. As illustrated, the method 800 includes a number of enumerated actions, but embodiments of the method 800 may include additional actions before, after, and in between the enumerated actions. In some embodiments, one or more of the enumerated actions may be omitted or performed in a different order. The method 800 may be implemented in conjunction with the method 400, the configuration 500, and/or the scheme 600 discussed above in relation to FIGS. 4, 5, and/or 6, respectively. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a, the sidelink receiving UE 315b, and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 800.

At action 805, the BS 305 determines the sidelink (e.g., the sidelink 320) associated with the sidelink transmitting UE 315a has a higher priority than the direct link (e.g., the direct link 310) of the BS 305, for example, based on a sidelink traffic priority indicated by the measurement report received from the direct link receiving UE 315c as discussed above in method 400. For instance, the BS 305 may perform action 805 as part of action 460 of the method 400 of FIG. 4.

At action 810, in response to determining the sidelink has a higher traffic priority than the direct link, the BS 305 transmits a DL communication signal (e.g., DCI and/or DL data) to the direct link receiving UE 315c in a resource (e.g., a DL resource) shared by the sidelink and the direct link using a reduced transmission power. For instance, the BS 305 may normally transmit DL communications using a first transmission power and may use a second transmission power reduced from the first transmission power (e.g., by about 3 decibels (dB), 4 dB, 5 dB, 6 dB or more) for the DL communication signal in the DL resource shared by the sidelink. The BS 305 may determine a backoff for the second transmission power based on the measurement report received from the direct link receiving UE 315c. The transmission of the DL communication signal with the reduced second transmission power can reduce the amount of interference to the sidelink or with a minimal amount of interference to the sidelink. In some aspects, the BS 305 may also notify the direct link receiving UE 315c of the transmission power reduction used for the DL communication signal in the DL resource.

At action 820, the sidelink transmitting UE 315a transmits a sidelink communication signal (e.g., SCI and/or sidelink data) to the sidelink receiving UE 315b over the sidelink using the resource shared by the sidelink and the direct link. The sidelink transmitting UE may transmit the sidelink communication signal in the DL resource concurrent with the BS 305 transmitting the DL communication signal. For instance, the sidelink transmitting UE 315a may monitor for an interference feedback indicator and may transmit the sidelink communication signal based on no interference feedback indication being received. In some aspects, when the sidelink has a high traffic priority, the sidelink transmitting UE 315a may transmit the sidelink transmission without monitoring for an interference feedback indication.

FIG. 9 is a signaling diagram illustrating an interference management method 900 according to some aspects of the present disclosure. The method 900 may be implemented among the BS 305, the sidelink transmitting (SL Tx) UE 315a, the sidelink receiving (Rx) UE 315b, and the direct link receiving (Rx) UE 315c in the scenario 300 discussed above in relation to FIG. 3. Although FIG. 9 illustrates one BS 305, one sidelink transmitting UE 315a, one sidelink receiving UE 315b, and one direct link receiving UE 315c, it should be understood that in other examples method 900 can be implemented between the BS 305 and any suitable number of sidelink transmitting UEs (e.g., 2, 3, 4, 5, 6 or more), any suitable number of sidelink receiving UE (e.g., 2, 3, 4, 5, 6, or more), any suitable number of direct link receiving UEs (e.g., 2, 3, 4, 5, 6 or more) sharing transmission resources. As illustrated, the method 900 includes a number of enumerated actions, but embodiments of the method 900 may include additional actions before, after, and in between the enumerated actions. In some embodiments, one or more of the enumerated actions may be omitted or performed in a different order. The method 900 may be implemented in conjunction with the method 400, the configuration 500, and/or the scheme 600 discussed above in relation to FIGS. 4, 5, and/or 6, respectively. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a, the sidelink receiving UE 315b, and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 900.

At action 905, the BS 305 determines the sidelink (e.g., the sidelink 320) associated with the sidelink transmitting UE 315a has a lower priority than the direct link (e.g., the direct link 310) of the BS 305, for example, based on a sidelink traffic priority indicated by the measurement report received from the direct link receiving UE 315c as discussed above in method 400. For instance, the BS 305 may perform action 905 as part of action 460 of the method 400 of FIG. 4.

At action 910, in response to determining the sidelink has a lower priority than the direct link, the BS 305 transmits a sidelink transmission cancellation request to the sidelink transmitting UE 315a.

At action 920, the BS 305 transmits a DL communication signal (e.g., DCI and/or DL data) to the direct link receiving UE 315c in a resource (e.g., a DL resource) shared by the sidelink and the direct link.

At action 930, in response to receiving the sidelink transmission cancellation request, the sidelink transmitting UE 315a refrains from transmitting a sidelink communication signal over the sidelink to the sidelink receiving UE 315b in the resource shared by the sidelink and the direct link as shown by the symbol “X”. The sidelink transmitting UE 315a may refrain from transmitting the sidelink communication signal by cancelling or postponing a sidelink transmission schedule, and/or or removing a prepared transport block associated with the sidelink communication from a transmission queue.

In some aspects, at action 912, if the sidelink transmitting UE 315a is out of the coverage of the BS 305, the BS 305 may transmit the sidelink transmission cancellation request to the direct link receiving UE 315c instructing the direct link receiving UE 315c to forward the sidelink transmission cancellation request. At action 914, the direct link receiving UE 315c may forward the sidelink transmission cancellation request to the sidelink transmitting UE 315a.

In some aspects, for decentralized interference management or handling, at action 916, the direct link receiving UE 315c may autonomously transmit the sidelink transmission cancellation request to the sidelink transmitting UE 315a based on an interference measured from the sidelink transmitting UE 315a (e.g., at action 440 of the method 400) and/or a traffic priority of the sidelink without being instructed by the BS 305. For instance, the direct link receiving UE 315c may determine the sidelink priority (based on the sidelink interference measurement resource in which the reference signal is detected) and determine the sidelink has a lower priority than the direct link, and thus the direct link receiving UE 315c may transmit the sidelink transmission cancellation request to the sidelink transmitting UE 315a.

In some aspects, the BS 305 may indicate a feedback resource (e.g., the resources 614 or 624) where the BS 305 may transmit the sidelink transmission cancellation request at action 910 or where the direct link receiving UE may transmit the sidelink transmission cancellation request at action 914 or 916 in a sidelink interference measurement resource and report configuration to the direct link receiving UE 315c and/or the sidelink transmitting UE 315a. Accordingly, the sidelink transmitting UE 315a may monitor the feedback resource. Upon receiving the sidelink transmission cancellation request in the feedback resource, the sidelink transmitting UE 315a may refrain from transmitting a sidelink communication signal to the sidelink receiving UE 315b over the sidelink. Alternatively, the BS 305 may configure the direct link receiving UE 315c and/or the sidelink transmitting UE 315a with a resource offset from a sidelink interference measurement resource for communicating an interference feedback indication.

In some aspects, the one or more sidelink interference measurement resources may include multiple sidelink interference measurement resources configured for a group of sidelink transmitting UEs including the sidelink transmitting UE 315a as discussed above. Thus, the BS 305 and/or the direct link receiving UE 315c may determine that the group of sidelink transmitting UEs may be associated with sidelinks having a lower traffic priority than the direct link. As such, the BS 305 and/or the direct link receiving UE 315c may transmit a groupcast message or a broadcast message including the sidelink transmission cancellation request for the group of sidelink transmitting UEs. In some instances, the BS 305 may transmit group common-downlink control information (GC-DCI) indicating the sidelink transmission cancellation request for the group of sidelink transmitting UEs. In general, the BS 305 (e.g., at actions 910 or 912) and/or the direct link receiving UE 315c (e.g., at actions 914 or 916) may transmit a unicast message, a groupcast message, or a broadcast message to indicate the sidelink transmission cancellation request.

FIG. 10 is a signaling diagram illustrating an interference management method 1000 according to some aspects of the present disclosure. The method 1000 may be implemented among the BS 305, the sidelink transmitting (SL Tx) UE 315a, the sidelink receiving (Rx) UE 315b, and the direct link receiving (Rx) UE 315c in the scenario 300 discussed above in relation to FIG. 3. Although FIG. 10 illustrates one BS 305, one sidelink transmitting UE 315a, one sidelink receiving UE 315b, and one direct link receiving UE 315c, it should be understood that in other examples method 1000 can be implemented among the BS 305 and any suitable number of sidelink transmitting UEs (e.g., 2, 3, 4, 5, 6 or more), any suitable number of sidelink receiving UE (e.g., 2, 3, 4, 5, 6, or more), any suitable number of direct link receiving UEs (e.g., 2, 3, 4, 5, 6 or more) sharing transmission resources. As illustrated, the method 1000 includes a number of enumerated actions, but embodiments of the method 1000 may include additional actions before, after, and in between the enumerated actions. In some embodiments, one or more of the enumerated actions may be omitted or performed in a different order. The method 1000 be implemented in conjunction with the method 400, the configuration 500, and/or the scheme 600 discussed above in relation to FIGS. 4, 5, and/or 6, respectively. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a, the sidelink receiving UE 315b, and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 1000.

At action 1005, the BS 305 determines the sidelink (e.g., the sidelink 320) associated with the sidelink transmitting UE 315a has a lower priority than the direct link (e.g., the direct link 310) of the BS 305, for example, based on a sidelink traffic priority indicated by the measurement report received from the direct link receiving UE 315c as discussed above in method 400. For instance, the BS 305 may perform action 1005 as part of action 460 of the method 400 of FIG. 4.

At action 1010, in response to determining the sidelink has a lower priority than the direct link, the BS 305 transmits a sidelink power control configuration to the sidelink transmitting UE 315a. The sidelink power control configuration may indicate a power backoff request and/or a power backoff amount.

At action 1020, the BS 305 transmits a DL communication signal (e.g., DCI and/or DL data) to the direct link receiving UE 315c in a resource (e.g., a DL resource) shared by the sidelink and the direct link.

At action 1030, in response to receiving the sidelink power control configuration, the sidelink transmitting UE 315a transmits a sidelink communication signal (e.g., SCI and/or sidelink data) over the sidelink to the sidelink receiving UE 315b in the resource shared by the sidelink and the direct link at a reduced power. For instance, the sidelink transmitting UE 315a may normally transmit a sidelink transmission using a first transmission power and may use a second transmission power reduced from the first transmission power (e.g., by about 3 decibels (dB), 4 dB, 5 dB, 6 dB or more) for the sidelink communication signal in the DL resource shared by the sidelink. The sidelink transmitting UE 315a may determine the power backoff for the second transmission power based on the backoff amount indicated by the sidelink power control configuration or a preconfigured backoff amount.

Similar to the method 900, at action 1012, if the sidelink transmitting UE 315a is out of the coverage of the BS 305, the BS 305 may transmit the sidelink power control configuration to the direct link receiving UE 315c instructing the direct link receiving UE 315c to forward the sidelink power control configuration. At action 1014, the direct link receiving UE 315c may forward the sidelink power control configuration to the sidelink transmitting UE 315a.

For decentralized interference management or handling, at action 1016, the direct link receiving UE 315c may autonomously transmit the sidelink power control configuration to the sidelink transmitting UE 315a based on an interference measured from the sidelink transmitting UE 315a (e.g., at action 440 of the method 400) and/or a traffic priority of the sidelink without being instructed by the BS 305.

Additionally, similar to the method 900, the BS 305 and/or the direct link receiving UE 315c may transmit the sidelink power control configuration in a feedback resource indicated by the BS 305 or based on a preconfigured offset and the sidelink transmitting UE 315a may monitor for the sidelink power control configuration in the feedback resource,

Further, similar to the method 900, the one or more sidelink interference measurement resources may include multiple sidelink interference measurement resources configured for a group of sidelink transmitting UEs including the sidelink transmitting UE 315a as discussed above. Thus, the BS 305 and/or the direct link receiving UE 315c may determine that the group of sidelink transmitting UEs may be associated with sidelinks having a lower traffic priority than the direct link. As such, the BS 305 and/or the direct link receiving UE 315c may transmit a groupcast message or a broadcast message including the sidelink power control configuration for the group of sidelink transmitting UEs. In some instances, the BS 305 may transmit GC-DCI indicating the sidelink power control configuration for the group of sidelink transmitting UEs. In general, the BS 305 (e.g., at actions 1010 or 1012) and/or the direct link receiving UE 315c (e.g., at actions 1014 or 1016) may transmit a unicast message, a groupcast message, or a broadcast message to indicate the sidelink power control configuration.

While the methods 700-1000 are described in the context of the BS 305 and/or the direct link receiving UE 315c determining whether to mute or cancel a sidelink transmission or a direct link transmission in a shared resource (shared by the sidelink and the direct link) and/or whether to reduce a transmission power of a sidelink transmission or a direct link transmission in the shared resource based on a sidelink traffic priority relative to the direct link traffic priority, the BS 305 and/or the direct link receiving UE 315c may perform the determination additionally or alternatively based on an amount of interference and/or a spatial direction of the interference.

For instance, if the interference measurement indicates a low RSRP or a low RSSI (e.g., below a threshold), the BS 305 may not transmit a sidelink transmission cancellation request or a sidelink power control configuration to the sidelink transmitting UE 315a or cancel a DL transmission in the shared resource. However, if the interference measurement indicates a high RSRP or a high RSSI (e.g., above a threshold), the BS 305 may refrain from transmitting the DL communication signal in the shared resource or transmit a sidelink transmission cancellation request or a sidelink power control configuration to the sidelink transmitting UE 315a.

In some instances, if the BS 305 determines that the interference is from a different spatial or beam direction than a spatial or beam direction of the DL communication signal to be transmitted to the direct link receiving UE 315c, the BS 305 may not transmit a sidelink transmission cancellation request or a sidelink power control configuration to the sidelink transmitting UE 315a or cancel a DL transmission in the shared resource. However, if the BS 305 determines that the interference is from a similar spatial or beam direction as a spatial or beam direction of the DL communication signal to be transmitted to the direct link receiving UE 315c, the BS 305 may refrain from transmitting the DL communication signal in the shared resource or transmit a sidelink transmission cancellation request or a sidelink power control configuration to the sidelink transmitting UE 315a.

In some aspects, the CLI-based interference management mechanisms discussed above in relation to FIGS. 4-10 may be suitable for a longer term interference handling. For instance, the BS 305 may apply a long-term averaging over interference caused by the sidelink transmitting UE 315a as reported by the direct link receiving UE 315c. The BS 305 may determine whether to mute or cancel a sidelink transmission or a direct link transmission in a shared resource (shared by the sidelink and the direct link) and/or whether to reduce a transmission power of a sidelink transmission or a direct link transmission in the shared resource based on an averaged measurement over a time period (e.g., tens of milliseconds, hundreds of milliseconds, or a few seconds).

FIGS. 11-12 are discussed in relation to each other and in relation to FIG. 3 to illustrate sidelink interference measurement resource and report configuration, interference measurement reporting, and/or interference handling based on CTS. FIG. 11 is a signaling diagram illustrating an interference management method 1100 according to some aspects of the present disclosure. The method 1100 may be implemented among the BS 305, the sidelink transmitting (SL Tx) UE 315a (e.g., an aggressor), the sidelink receiving (SL Rx) UE 315b, and the direct link receiving (Rx) UE 315c (e.g., a victim of the interference) in the scenario 300 discussed above in relation to FIG. 3. Although FIG. 11 illustrates one BS 305, one sidelink transmitting UE 315a, one sidelink receiving UE 315b, and one direct link receiving UE 315c, it should be understood that in other examples method 1100 can be implemented among the BS 305 and any suitable number of sidelink transmitting UEs (e.g., 2, 3, 4, 5, 6 or more), any suitable number of sidelink receiving UEs (e.g., 2, 3, 4, 5, 6 or more), and any suitable number of direct link receiving UEs (e.g., 2, 3, 4, 5, 6 or more) sharing transmission resources. As illustrated, the method 1100 includes a number of enumerated actions, but embodiments of the method 1100 may include additional actions before, after, and in between the enumerated actions. In some embodiments, one or more of the enumerated actions may be omitted or performed in a different order. The method 1100 may be implemented in conjunction with the configuration 500 and/or the scheme 600 discussed above in relation to FIGS. 5 and/or 6, respectively. In some aspects, the BS 305 may utilize components, such as the processor 1302, the memory 1304, the interference module 1308, the communication module 1309, the transceiver 1310, the modem 1312, and the one or more antennas 1316 of the BS 1300 as shown in FIG. 13, to perform operations of the method 400. The sidelink transmitting UE 315a, the sidelink receiving UE 315b, and the direct link receiving UE 315c may each utilize components, such as the processor 1402, the memory 1404, the interference module 1408, the communication module 1409, the transceiver 1410, the modem 1412, and the one or more antennas 1416 of the UE 1400 as shown in FIG. 14, to perform operations of the method 1100.

Generally speaking, the method 1100 includes features similar to method 400 in many respects. However, in the method 1100, the BS 305 may configure the direct link receiving UE 315c (e.g., a potential victim) to transmit a CTS in a sidelink interference measurement resource and may configure the sidelink transmitting UE 315a (e.g., the aggressor) to measure interference from the sidelink interference measurement resources. If the aggressor (the sidelink transmitting UE 315a) does not detect a CTS from the victim (the direct link receiving UE 315c), the aggressor (the sidelink transmitting UE 315a) is allowed to transmit. The CTS may be a reference signal, which may be a wideband SRS, a wideband CSI-RS, a narrowband DMRS, or a narrowband sidelink synchronization signal as discussed above in relation to FIGS. 4 and 5.

In some aspects, the BS 305 may configure one or more transmission resources for sharing between a sidelink (e.g., the sidelink 320 between the sidelink transmitting UE 315a and the sidelink receiving UE 315b) and a direct link (e.g., the direct link 310 between the BS 305 and the direct link receiving UE 315c) as discussed above at action 405 of the method 400. The BS 305 may configure sidelink interference measurement resources for sidelink interference measurement and reporting using similar mechanisms at action 407 of the method 400 as discussed above in relation to FIG. 4. The BS 305 may determine a sidelink interference measurement and reporting configuration similar to the configuration 500 discussed above in relation to FIG. 5. However, the configuration may indicate reference signal types for the direct link receiving UE 315c to transmit reference signals in the one or more sidelink interference measurement resources. For instance, the configuration may indicate whether the direct link receiving UE 315c is to transmit a wideband reference signal (e.g., SRS or CSI-RS) or a narrowband signal (e.g., DMRS or sidelink synchronization signal) in a certain sidelink interference measurement resource. The configuration may indicate report types for the sidelink transmitting UE 315a to report an interference measurement determined from the one or more sidelink interference measurement resources. For instance, the configuration may indicate whether the sidelink transmitting UE 315a is to report a RSRP or a RSSI and/or whether to report priority information and/or interference direction information for a certain sidelink interference measurement resource. The configuration may also include reporting resource (e.g., the resources 612 and 622) and/or interference feedback resource (e.g., the resources 614 and 624) configurations similar to the configuration 500. In some aspects, the BS 305 may also assign each sidelink interference measurement resource with a direct link traffic priority, and thus the direct link receiving UE 315c may select a sidelink interference measurement resource for transmitting a reference signal based on a traffic priority of the direct link.

At action 1110, the BS 305 transmits a first configuration and a first instruction to the direct link receiving UE 315c. The first configuration may include the configuration (e.g., the configuration 500) determined by the BS 305. The first instruction may instruct the direct link receiving UE 315c to transmit a reference signal in the one or more sidelink interference measurement resources as indicated by the first configuration. The BS 305 may transmit the first instruction to the direct link receiving UE 315c based on the direct link receiving UE 315c being impacted by the interference. In some instances, the first instruction may be part of the first configuration. For instance, the first configuration may be an RRC configuration and may include the first instruction enabling or disabling a reference signal transmission in a certain sidelink interference measurement resource. In some other instances, the first instruction may be a trigger separate from the first configuration. For instance, the first configuration may be an RRC configuration and the first instruction may be a separate RRC configuration or indicated in PDCCH DCI.

At action 1120, the BS 305 transmits a second configuration and a second instruction to the sidelink transmitting UE 315a. The second configuration may include the configuration (e.g., the configuration 500) determined by the BS 305. The second instruction may instruct the sidelink transmitting UE 315a to determine an interference measurement in the one or more sidelink interference measurement resources as indicated by the second configuration. In some instances, the second instruction may be part of the second configuration. For instance, the second configuration may be an RRC configuration and may include the second instruction enabling or disabling an interference report for a certain sidelink interference measurement resource. In some other instances, the second instruction may be a trigger separate from the second configuration. For instance, the second configuration may be an RRC configuration and the second instruction may be a separate RRC configuration or indicated in PDCCH DCI.

At action 1130, the direct link receiving UE 315c transmits a reference signal in an sidelink interference measurement resource as configured by the first sidelink interference measurement resource and configuration and the first instruction. As an example, the direct link receiving UE 315c transmits a reference signal in a first sidelink interference measurement resource of the one or more sidelink interference measurement resources. Depending on the reference signal type indicated by the first configuration, the direct link receiving UE 315c may transmit an SRS (based on an SRS waveform sequence assigned to the sidelink transmitting UE 315a), a CSI-RS, a DMRS, or a sidelink synchronization signal in the first sidelink interference measurement resource. In another example, the direct link receiving UE 315c may select the first sidelink interference measurement resource from the one or more sidelink interference measurement resources based on a traffic priority of the direct link. For instance, the first sidelink interference measurement resource may be assigned with a high traffic priority and a second sidelink interference measurement resource of the sidelink interference measurement resources may be assigned with a low traffic priority. The direct link receiving UE 315c may select the first sidelink interference measurement resource based on the direct link has high priority traffic.

At action 1140, the sidelink transmitting UE 315a determines a sidelink interference measurement as configured by the second sidelink interference measurement resource and configuration and the second instruction. As an example, the second configuration and the second instruction may instruct the sidelink transmitting UE 315a to report an interference measurement for each sidelink interference measurement resource. Depending on the report type indicated by the second configuration, the sidelink transmitting UE 315a may compute an RSRP or an RSSI for a reference signal in the sidelink interference measurement resource. In some aspects, the sidelink transmitting UE 315a may also determine a direct link traffic priority associated with the interference (e.g., the reference signal) based on a priority associated with a sidelink interference measurement resource in which the reference signal is received and measured. In some aspects, the sidelink transmitting UE 315a may also determine a beam direction or spatial direction in which the reference signal is received.

At action 1150, the sidelink transmitting UE 315a may determine whether to transmit a sidelink communication signal over the sidelink to the sidelink receiving UE 315b in a resource (e.g., a DL resource) shared by the direct link and the sidelink. In some aspects, if the sidelink transmitting UE 315a detected a reference signal in the first sidelink interference measurement resource, the sidelink transmitting UE 315a may refrain from transmitting the sidelink communication signal in the shared resource. However, if the sidelink transmitting UE 315a does not detect a reference signal in the first sidelink interference measurement resource, the sidelink transmitting UE 315a may proceed to transmit the sidelink communication signal in the shared resource at action 1160.

In some aspects, the sidelink transmitting UE 315a may determine whether to transmit the sidelink communication signal based on the at least one of the interference measurement, the interference directional information, or the traffic priority of the direct link. For instance, if the interference measurement indicates a low RSRP or a low RSSI (e.g., below a threshold), the sidelink transmitting UE 315a may proceed to transmit the sidelink communication signal in the shared resource at action 1160. However, if the interference measurement indicates a high RSRP or a high RSSI (e.g., above a threshold), the sidelink transmitting UE 315a may refrain from transmitting the sidelink communication signal in the shared resource or reduce a transmission power of the sidelink communication signal transmission.

In some instances, if the sidelink transmitting UE 315a determines that the interference is from a different spatial or beam direction than a spatial or beam direction of the sidelink communication signal to be transmitted to the sidelink receiving UE 315b, the sidelink transmitting UE 315a may proceed to transmit the sidelink communication signal in the shared resource at action 1160. However, if the sidelink transmitting UE 315a determines that the interference is from a similar spatial or beam direction as a spatial or beam direction of the sidelink communication signal to be transmitted to the sidelink receiving UE 315b, the sidelink transmitting UE 315a may refrain from transmitting the sidelink communication signal in the shared resource or reduce a transmission power of the sidelink communication signal transmission.

In some instances, if the sidelink transmitting UE 315a determines that the direct link has a lower priority than the sidelink (e.g., based on a priority of the first sidelink interference measurement resource in which the reference signal is detected), the sidelink transmitting UE 315a may proceed to transmit the sidelink communication signal in the shared resource at action 1160. However, if the sidelink transmitting UE 315a determines that the direct link has a higher priority than the sidelink, the sidelink transmitting UE 315a may refrain from transmitting the sidelink communication signal in the shared resource or reduce a transmission power of the sidelink communication signal transmission.

In some aspects, the sidelink transmitting UE 315a may monitor for an interference feedback indication from the BS 305, for example, in a feedback resource indicated by the second configuration. If the sidelink transmitting UE 315a does not receive an interference feedback indication from the BS 305, the sidelink transmitting UE 315a may proceed to transmit the sidelink communication signal in the shared resource at action 1160. If the sidelink transmitting UE 315a receives an interference feedback indication indicating a sidelink transmission cancellation request, the sidelink transmitting UE 315a may refrain from transmitting the sidelink communication signal in the shared resource. If the sidelink transmitting UE 315a receives an interference feedback indication indicating a sidelink power control configuration (e.g., indicating power backoff), the sidelink transmitting UE 315a may transmit the sidelink communication signal using a reduced transmission power (e.g., with the indicated power backoff).

At action 1170, the BS 305 transmits a DL communication signal to the direct link receiving UE 315c in the resource shared by the sidelink and the direct link. As can be observed, the method 1110 utilizes decentralized interference handling, where the BS 305 relies on the sidelink transmitting UE 315a (e.g., the aggressor) to reduce a transmission power of the sidelink communication signal in the shared resource or yield access in the shared resource to the DL communication signal.

As discussed above, the direct link receiving UE 315c may transmit various types of reference signals for interference measurement. When the direct link receiving UE 315c transmits a wideband SRS, the BS 305 may determine CSI for the direct link from the SRS. The BS 305 may also configure other sidelink UEs to monitor for the wideband SRS. When the direct link receiving UE 315c transmits a narrowband reference signal such as the sidelink synchronization signal (e.g., including a PSS, SSS, and/or a PSBCH signal), other sidelink UEs may perform sidelink synchronization based on the sidelink synchronization signal.

In some aspects, the method 1100 can provide dynamic interference handling. For instance, the configured one or more sidelink interference measurement resources can be associated with a direct link schedule and a sidelink schedule as shown in FIG. 12.

FIG. 12 illustrates an interference management scheme 1200 according to some aspects of the present disclosure. The scheme 1200 may be employed by a BS such as the BSs 105 and/or the BS 305 and a UE such as the UEs 115 and/or 315 for sidelink interference measurement and reporting. In FIG. 12, the x-axis represents time in some arbitrary units. The scheme 600 may be implemented in conjunction with the configuration 500, the scheme 600, and the method 1100 discussed above in relation to FIGS. 5, 6, and/or 11, respectively.

FIG. 12 illustrates a timeline 1201 and a timeline 1203. The timeline 1201 illustrates transmissions for a BS 305 and a direct link receiving UE 315c over a direct link 310 as shown in FIG. 3. The timeline 1203 illustrates transmissions for a sidelink transmitting UE 315a and a sidelink receiving UE 315b over a sidelink 320 as shown in FIG. 3.

As shown by the timeline 1201, the BS 305 may transmit a DL scheduling grant 1210 (e.g., DCI) to a direct link receiving UE 315c during a first period 1204, for example, over a direct link. The DL scheduling grant 1210 schedules a DL communication signal 1214 (e.g., PDSCH or DL data) in a second period 1208. The DL scheduling grant 1210 may schedule the DL communication signal 1214 in a resource shared by the direct link and the sidelink. The first period 1204 and the second period 1208 are spaced apart by a third period 1206 (e.g., a gap period). The first period 1204, the second period 1208, and the third period 1206 are consecutive periods within a period 1202. The period 1202 may correspond to a slot 202 as discussed above in relation to FIG. 2.

The third period 1206 may include a sidelink interference measurement resource 1207 (shown by the pattern-filled box) for interference measurement. The sidelink interference measurement resource 1207 may be spaced apart from the first period 1204 in time by a gap 1216 and may be spaced apart from the second period 1208 in time by a gap 1217. The gaps 1216 and 1217 may provide time for the direct link receiving UE 315c to switch its frontend between transmit and receive. The sidelink interference measurement resource 1207 may occupy any suitable portion of a frequency band used by the direct link and the sidelink. There may be no transmission from the BS 305 and/or the sidelink transmitting UE 315a during the third period 1206. The BS 305 may trigger the direct link receiving UE 315c to transmit a CTS 1212 in the sidelink interference measurement resource. Accordingly, the direct link receiving UE 315c may transmit the CTS 1212 in the sidelink interference measurement resource within the third period 1206. The BS 305 may configure the CTS 1212 to be a wideband reference signal (e.g., SRS or CSI-RS) or a narrowband reference signal (e.g., DMRS, sidelink synchronization signal) as discussed above in relation to FIG. 11. In some aspects, the BS 305 may trigger the direct link receiving UE 315c to transmit the CTS 1212 based on the direct link receiving UE 315c being a cell-edge of an area served by the BS 305 and/or based on the direct link receiving UE 315c previously reported an interference from the sidelink (e.g., by employing the method 400).

As shown by the timeline 1203, a sidelink transmitting UE 315a may transmit a sidelink (SL) scheduling grant 1220 (e.g., DCI) to a sidelink receiving UE 315b during the first period 1204, for example, over a sidelink (e.g., the sidelink 320). The sidelink scheduling grant 1220 schedules a sidelink communication signal 1224 (e.g., PSSCH or sidelink data) in the second period 1208. The sidelink scheduling grant 1220 may schedule the sidelink communication signal 1224 in the resource shared by the direct link and the sidelink. The sidelink transmitting UE 315a may monitor for a CTS 1212 during the third period 1206. The sidelink transmitting UE 315a may determine whether to proceed with the transmission of the sidelink communication signal 1224 scheduled for the second period 1208 based on the CTS monitoring. The sidelink transmitting UE 315a may use the same mechanisms as discussed above at action 1150.

For instance, if the sidelink transmitting UE 315a detected the CTS 1212 during the third period 1206, the sidelink transmitting UE 315a may refrain from transmitting the sidelink communication signal 1224. However, if the sidelink transmitting UE 315a does not detect the CTS during the third period 1206 in the first sidelink interference measurement resource, the sidelink transmitting UE 315a may proceed to transmit the sidelink communication signal 1224 in the shared resource. In some other instances, the sidelink transmitting UE 315a may determine whether to transmit the sidelink communication signal 1224 based on the traffic priority of the direct link relative the traffic priority of the sidelink. For instance, if the sidelink transmitting UE 315a determines that the direct link has a lower priority than the sidelink (e.g., based on a priority of the first sidelink interference measurement resource in which the CTS 1212 is detected), the sidelink transmitting UE 315a may proceed to transmit the sidelink communication signal 1224 in the shared resource. However, if the sidelink transmitting UE 315a determines that the direct link has a higher priority than the sidelink, the sidelink transmitting UE 315a may refrain from transmitting the sidelink communication signal 1224 in the shared resource or reduce a transmission power for the sidelink communication signal 1224.

As can be observed from the scheme 1200, the CTS-based interference management may be more dynamic than the CLI-based interference management. As such, the CTS-based interference management may provide a faster response to interference changes, and thus may be more desirable in some situations.

FIG. 13 is a block diagram of an exemplary BS 1300 according to some aspects of the present disclosure. The BS 1300 may be a BS 105 in the network 100 as discussed above in FIG. 1 or a BS 305 as discussed above in FIG. 3. As shown, the BS 1300 may include a processor 1302, a memory 1304, an interference module 1308, a communication module 1309, a transceiver 1310 including a modem subsystem 1312 and a RF unit 1314, and one or more antennas 1316. These elements may be coupled with one another. The term “coupled” may refer to directly or indirectly coupled or connected to one or more intervening elements. For instance, these elements may be in direct or indirect communication with each other, for example via one or more buses.

The processor 1302 may have various features as a specific-type processor. For example, these may include a CPU, a DSP, an ASIC, a controller, a FPGA device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1304 may include a non-transitory computer-readable medium. The memory 1304 may store instructions 1306. The instructions 1306 may include instructions that, when executed by the processor 1302, cause the processor 1302 to perform operations described herein, for example, aspects of FIGS. 2-12. Instructions 1306 may also be referred to as program code. The program code may be for causing a wireless communication device to perform these operations, for example by causing one or more processors (such as processor 1302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

Each of the interference module 1308 and the communication module 1309 may be implemented via hardware, software, or combinations thereof. For example, each of the interference module 1308 and the communication module 1309 may be implemented as a processor, circuit, and/or instructions 1306 stored in the memory 1304 and executed by the processor 1302. In some examples, the interference module 1308 and the communication module 1309 can be integrated within the modem subsystem 1312. For example, the interference module 1308 and the communication module 1309 can be implemented by a combination of software components (e.g., executed by a DSP or a general processor) and hardware components (e.g., logic gates and circuitry) within the modem subsystem 1312.

The interference module 1308 and the communication module 1309 may coordinate with components of the BS 1300 to perform various aspects of the present disclosure, for example, aspects of FIGS. 2-12. In some aspects, the interference module 1308 is configured to determine one or more sidelink interference measurement resources for determining an interference from at least a first sidelink to a direct link. The first sidelink may be associated with a first UE (e.g., the UEs 115 and/or 315), and the direct link may be between the BS 1300 and a second UE different from the first UE. The first UE may be a sidelink transmitting UE (e.g., the sidelink transmitting UE 315a) that initiates a transmission over the first sidelink in a transmission resource (e.g., time-frequency resource) shared by the first sidelink and the direct link. The second UE (e.g., the UEs 115 and/or 315) may be a direct link receiving UE (e.g., the direct link receiving UE 315c) that receives a DL transmission from the BS 1300 in the shared transmission resource. The interference module 1308 is further configured to transmit a configuration indicating the one or more sidelink interference measurement resources to at least one of the first UE or the second UE.

In some aspects, the interference module 1308 is configured to configure the first UE (the aggressor) to transmit a reference signal in a first sidelink interference measurement resource of the one or more sidelink interference measurement resource and configure the second UE (the victim) to determine and report an interference measurement and/or a traffic priority of the first sidelink based on the first sidelink interference measurement resource as discussed above in relation to FIG. 4. In some aspects, the interference module 1308 is configured to manage interference from the first sidelink to the direct link as discussed above in relation to FIGS. 7-10.

In some aspects, the interference module 1308 is configured to configure the second UE (the victim) to transmit a reference signal in a first sidelink interference measurement resource of the one or more sidelink interference measurement resource and configure the first UE (the aggressor) to determine an interference measurement and/or a traffic priority of the direct link based on the first sidelink interference measurement resource as discussed above in relation to FIGS. 11-12.

In some aspects, the communication module 1309 is configured to transmit a DL scheduling grant (e.g., DCI) to the second UE and a DL communication signal (e.g., DL data) to the second UE based on the DL scheduling grant as discussed above in relation to FIGS. 8-12.

As shown, the transceiver 1310 may include the modem subsystem 1312 and the RF unit 1314. The transceiver 1310 can be configured to communicate bi-directionally with other devices, such as the UEs 115 and/or another core network element. The modem subsystem 1312 may be configured to modulate and/or encode data according to a MCS, e.g., a LDPC coding scheme, a turbo coding scheme, a convolutional coding scheme, a digital beamforming scheme, etc. The RF unit 1314 may be configured to process (e.g., perform analog to digital conversion or digital to analog conversion, etc.) modulated/encoded data (e.g., RRC configuration, DCI, sidelink interference measurement and report configurations, reference signal transmission instruction, measurement report request, interference feedback indication, DL communication signal) from the modem subsystem 1312 (on outbound transmissions) or of transmissions originating from another source such as a UE 115. The RF unit 1314 may be further configured to perform analog beamforming in conjunction with the digital beamforming. Although shown as integrated together in transceiver 1310, the modem subsystem 1312 and/or the RF unit 1314 may be separate devices that are coupled together at the BS 105 to enable the BS 105 to communicate with other devices.

The RF unit 1314 may provide the modulated and/or processed data, e.g. data packets (or, more generally, data messages that may contain one or more data packets and other information), to the antennas 1316 for transmission to one or more other devices. This may include, for example, transmission of information to complete attachment to a network and communication with a camped UE 115 according to some aspects of the present disclosure. The antennas 1316 may further receive data messages transmitted from other devices and provide the received data messages for processing and/or demodulation at the transceiver 1310. The transceiver 1310 may provide the demodulated and decoded data (e.g., SRS, CSI-RS, DMRS, sidelink interference measurement reports) to the interference module 1308 and/or the communication module 1309 for processing. The antennas 1316 may include multiple antennas of similar or different designs in order to sustain multiple transmission links.

In some aspects, the processor 1302 is configured to coordinate with the interference module 1308 to determine one or more sidelink interference measurement resources for determining an interference from at least a first sidelink to a direct link. The first sidelink is associated with a first UE, and the direct link is between the BS 1300 and a second UE different from the first UE. The transceiver 1310 is configured to coordinate with the interference module 1308 and/or the communication module 1309 to transmit a configuration indicating the one or more sidelink interference measurement resources.

In an aspect, the BS 1300 can include multiple transceivers 1310 implementing different RATs (e.g., NR and LTE). In an aspect, the BS 1300 can include a single transceiver 1310 implementing multiple RATs (e.g., NR and LTE). In an aspect, the transceiver 1310 can include various components, where different combinations of components can implement different RATs.

FIG. 14 is a block diagram of an exemplary UE 1400 according to some aspects of the present disclosure. The UE 1400 may be a UE 115 as discussed above with respect to FIG. 1 or a UE 315 as discussed above in FIG. 3. As shown, the UE 1400 may include a processor 1402, a memory 1404, an interference module 1408, a communication module 1409, a transceiver 1410 including a modem subsystem 1412 and a radio frequency (RF) unit 1414, and one or more antennas 1416. These elements may be coupled with one another. The term “coupled” may refer to directly or indirectly coupled or connected to one or more intervening elements. For instance, these elements may be in direct or indirect communication with each other, for example via one or more buses.

The processor 1402 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1402 may also be implemented as a combination of computing devices, e.g., a combination of a DSP and a microprocessor, a plurality of microprocessors, one or more microprocessors in conjunction with a DSP core, or any other such configuration.

The memory 1404 may include a cache memory (e.g., a cache memory of the processor 1402), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1404 includes a non-transitory computer-readable medium. The memory 1404 may store, or have recorded thereon, instructions 1406. The instructions 1406 may include instructions that, when executed by the processor 1402, cause the processor 1402 to perform the operations described herein with reference to the UEs 115 in connection with aspects of the present disclosure, for example, aspects of FIGS. 2-12. Instructions 1406 may also be referred to as program code, which may be interpreted broadly to include any type of computer-readable statement(s) as discussed above with respect to FIG. 13.

Each of the interference module 1408 and the communication module 1409 may be implemented via hardware, software, or combinations thereof. For example, each of the interference module 1408 and the communication module 1409 may be implemented as a processor, circuit, and/or instructions 1406 stored in the memory 1404 and executed by the processor 1402. In some examples, the interference module 1408 and the communication module 1409 can be integrated within the modem subsystem 1412. For example, the interference module 1408 and the communication module 1409 can be implemented by a combination of software components (e.g., executed by a DSP or a general processor) and hardware components (e.g., logic gates and circuitry) within the modem subsystem 1412.

The interference module 1408 and the communication module 1409 may coordinate with components of the UE 1400 to perform various aspects of the present disclosure, for example, aspects of FIGS. 2-12. In some aspects, the interference module 1408 is configured to receive, from a BS (e.g., the BSs 105, 305, and/or 1300), a configuration indicating one or more sidelink interference measurement resources for determining an interference from a sidelink to a direct link of the BS. The interference module 1408 is further configured to communicate, with a second UE, a reference signal in at least a first sidelink interference measurement resource of the one or more sidelink interference measurement resources.

In some aspects, the UE 1400 is associated with the sidelink and the second UE is associated with the direct link of the BS. For instance, the UE 1400 may correspond to the sidelink transmitting UE 315a and the second UE may correspond to the direct link receiving UE 315c as shown in FIG. 3. The interference module 1408 is configured to communicate the reference signal by transmitting the reference signal to the second UE based on the configuration as discussed above in relation to FIG. 4. The interference module 1408 is further configured to monitor for an interference feedback indication and determine whether to transmit a sidelink communication signal in a resource (e.g., a DL resource) shared by the direct link and the sidelink, for example, as discussed above in relation to FIGS. 7-10.

In some aspects, the UE 1400 is associated with the sidelink and the second UE is associated with the direct link of the BS. For instance, the UE 1400 may correspond to the sidelink transmitting UE 315a and the second UE may correspond to the direct link receiving UE 315c as shown in FIG. 3. The interference module 1408 is configured to communicate the reference signal by receiving, from the second UE in the first sidelink interference measurement resource, the reference signal, for example, as discussed above in relation to FIGS. 11-12. The interference module 1408 is also configured to determine at least one of an interference measurement (e.g., RSRP or RSSI), interference directional information, or a traffic priority of the direct link based on the received reference signal. The interference module 1408 is configured to determine whether to transmit a sidelink communication signal over the sidelink based on the at least one of the interference measurement, the interference directional information, or the traffic priority of the direct link, for example, as discussed above in relation to FIGS. 11-12.

In some aspects, the UE 1400 is associated with the direct link of the BS and the second UE is associated with the sidelink. For instance, the UE 1400 may correspond to the direct link receiving UE 315c and the second UE may correspond to the sidelink transmitting UE 315a as shown in FIG. 3. The interference module 1408 is configured to communicate by receiving, from the second UE in the first sidelink interference measurement resource, the reference signal. The interference module 1408 is also configured to determine at least one of an interference measurement (e.g., RSRP or RSSI), directional interference information, an identifier of the second UE, or a traffic priority of the sidelink based on the reference signal. The interference module 1408 is also configured to transmit a measurement report including the to the BS, for example, as discussed above in relation to FIG. 4. In some aspects, the interference module 1408 is also configured to determine an interference feedback indication for the second UE or relay an interference feedback indication from the BS to the second UE, for example, as discussed above in relation to FIGS. 9-10.

In some aspects, the UE 1400 is associated with the direct link and the second UE is associated with the sidelink. For instance, the UE 1400 may correspond to the direct link receiving UE 315c and the second UE may correspond to the sidelink transmitting UE 315a as shown in FIG. 3. The interference module 1408 is configured to communicate the reference signal by transmitting, in the first sidelink interference measurement resource, the reference signal based on the configuration, for example, as discussed above in relation to FIGS. 11-12.

In some aspects, the communication module 1409 is configured to receive a DL scheduling grant (e.g., DCI) from a BS (e.g., the BSs 105, 305, and/or 1300), receive a DL communication signal (e.g., DL data) from the BS, receive a sidelink scheduling grant from the second UE, receive a sidelink communication from the second UE, transmit a sidelink scheduling grant to the second UE, and/or transmit a sidelink communication to the second UE.

As shown, the transceiver 1410 may include the modem subsystem 1412 and the RF unit 1414. The transceiver 1410 can be configured to communicate bi-directionally with other devices, such as the BSs 105. The modem subsystem 1412 may be configured to modulate and/or encode the data from the memory 1404 and/or the interference module 1408 according to a modulation and coding scheme (MCS), e.g., a low-density parity check (LDPC) coding scheme, a turbo coding scheme, a convolutional coding scheme, a digital beamforming scheme, etc. The RF unit 1414 may be configured to process (e.g., perform analog to digital conversion or digital to analog conversion, etc.) modulated/encoded data (e.g., SRS, CSI-RS, DMRS, sidelink interference measurement reports, interference feedback indication, SCI, sidelink communication signal) from the modem subsystem 1412 (on outbound transmissions) or of transmissions originating from another source such as a UE 115 or a BS 105. The RF unit 1414 may be further configured to perform analog beamforming in conjunction with the digital beamforming. Although shown as integrated together in transceiver 1410, the modem subsystem 1412 and the RF unit 1414 may be separate devices that are coupled together at the UE 115 to enable the UE 115 to communicate with other devices.

The RF unit 1414 may provide the modulated and/or processed data, e.g. data packets (or, more generally, data messages that may include one or more data packets and other information), to the antennas 1416 for transmission to one or more other devices. The antennas 1416 may further receive data messages transmitted from other devices. The antennas 1416 may provide the received data messages for processing and/or demodulation at the transceiver 1410. The transceiver 1410 may provide the demodulated and decoded data (e.g., RRC configuration, DCI, sidelink interference measurement and report configurations, reference signal transmission instruction, measurement report request, interference feedback indication, DL communication signal, SCI, sidelink communication signal) to the interference module 1408 for processing. The antennas 1416 may include multiple antennas of similar or different designs in order to sustain multiple transmission links. The RF unit 1414 may configure the antennas 1416.

In some aspects, the transceiver 1310 is configured to coordinate with the interference module 1408 and/or the communication module 1409 to receive, from a BS, a configuration indicating one or more sidelink interference measurement resources for determining an interference from a sidelink to a direct link of the BS and communicate, with a second UE, a reference signal in at least a first sidelink interference measurement resource of the one or more sidelink interference measurement resources.

In an aspect, the UE 1400 can include multiple transceivers 1410 implementing different RATs (e.g., NR and LTE). In an aspect, the UE 1400 can include a single transceiver 1410 implementing multiple RATs (e.g., NR and LTE). In an aspect, the transceiver 1410 can include various components, where different combinations of components can implement different RATs.

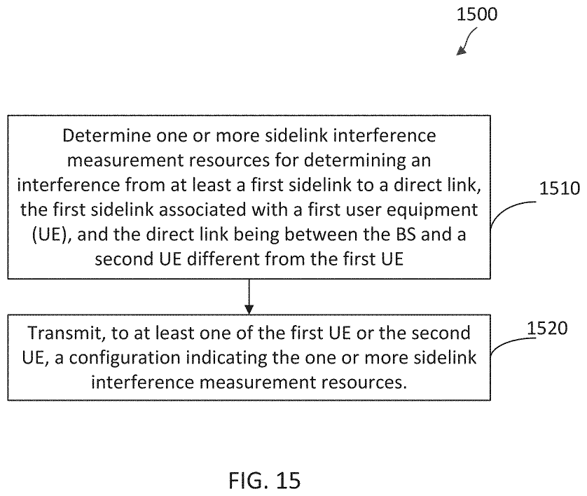

FIG. 15 is a flow diagram of a wireless communication method 1500 according to some aspects of the present disclosure. Aspects of the method 1500 can be executed by a computing device (e.g., a processor, processing circuit, and/or other suitable component) of a wireless communication device or other suitable means for performing the steps. For example, a wireless communication device, such as the BSs 105 or 305, may utilize one or more components, such as the processor 1302, the memory 1304, the interference module 1308, the communication module 1309, the transceiver 1310, the modem 1312, and the one or more antennas 1316, to execute the steps of method 1500. The method 1500 may employ similar mechanisms as described above in FIGS. 2-12. As illustrated, the method 1500 includes a number of enumerated steps, but aspects of the method 1500 may include additional steps before, after, and in between the enumerated steps. In some aspects, one or more of the enumerated steps may be omitted or performed in a different order.

At block 1510, a BS (e.g., the BS 105 or 305) determines one or more sidelink interference measurement resources for determining an interference from at least a first sidelink (e.g., the sidelink 320) to a direct link (e.g., the direct link 310). The first sidelink is associated with a first UE (e.g., the sidelink transmitting UE 315a), and the direct link is between the BS and a second UE (e.g., the direct link receiving UE 315c) different from the first UE. For instance, the BS may allocate the one or more sidelink interference measurement resources from radio frames as shown in FIG. 2. The BS 305 may determine the allocations based on channel conditions, traffic priorities of the first sidelink and/or the direct link, and/or traffic loads of the first sidelink and/or the direct link as discussed above in relation to FIG. 6. In some aspects, the BS may determine the one or more sidelink interference measurement resources to facilitate interference measurements and management when the first sidelink shares a downlink resource of the direct link. In some instances, the BS may utilize one or more components, such as the processor 1302, the memory 1304, the interference module 1308, the communication module 1309, the transceiver 1310, the modem 1312, and the one or more antennas 1316, to determine the one or more sidelink interference resources.

At block 1520, the BS transmits, to at least one of the first UE or the second UE, a configuration indicating the one or more sidelink interference measurement resources. In some instances, the BS may transmit the configuration to the first UE and the second UE to facilitate interference management. In some instances, the BS may utilize one or more components, such as the processor 1302, the memory 1304, the interference module 1308, the communication module 1309, the transceiver 1310, the modem 1312, and the one or more antennas 1316, to transmit the configuration indicating the one or more sidelink interference measurement resources.

In some aspects, the configuration may further indicate at least one of a measurement report type, a reference signal type, a bandwidth, a subcarrier spacing, a sidelink traffic priority, or a direct link traffic priority associated with the one or more sidelink interference measurement resources. In some aspects, the configuration may further indicate at least one of an RSRP measurement or an RSSI to be reported based on the one or more sidelink interference measurement resources. In some aspects, the configuration may further indicate at least one of a wideband reference signal (e.g., SRS or CSI-RS) or a narrowband reference signal (e.g., DMRS or a sidelink synchronization signal) to be transmitted in the one or more sidelink interference measurement resources. In some aspects, the configuration may further indicate a first sidelink interference measurement resource of the one or more sidelink interference measurement resources and a second sidelink interference measurement resource of the one or more sidelink interference measurement resources being associated with different traffic priorities.

In some aspects, the BS may further transmit, in a downlink resource, a downlink communication signal rate-matched around a first interference measurement resource of the one or more sidelink interference measurement resources that is at least partially overlapping with the downlink resource. In some aspects, the BS may further refrain from scheduling an uplink transmission in an uplink resource based on a first interference measurement resource of the one or more sidelink interference measurement resources being at least partially overlapping with the uplink resource.

In some aspects, the BS may utilize the CLI-based interference management discussed above in relation to FIGS. 4-10 to manage interference from the sidelink to the direct link. For instance, the BS may further transmit, to the first UE associated with the first sidelink, an instruction to transmit a reference signal in a first sidelink interference measurement resource of the one or more sidelink interference measurement resource. The BS may transmit the instruction to the first UE based on the first UE causing the interference to the direct link. The BS may further transmit, to the second UE over the direct link, an instruction to report an interference measurement based on the first sidelink interference measurement resource.

In some aspects, the BS may further receive, from the second UE based on the reference signal, a measurement report including at least one of the interference measurement (e.g., RSRP or RSSI) associated with the first sidelink, an identifier of the first UE associated with the first sidelink, or a traffic priority associated with the first sidelink. The BS may further determine, based on the measurement report, whether to transmit a downlink communication signal to the second UE. In some aspects, the BS may determine whether to transmit the downlink communication signal to the second UE and/or whether to transmit a sidelink transmission cancellation request or a sidelink power control configuration based on whether the sidelink has a higher priority than the direct link, for example, as discussed above in relation to FIGS. 7-10.

In some aspects, the BS may utilize CTS-based interference management as discussed above in relation to FIGS. 11-12 to manage interference from the sidelink to the direct link. For instance, the BS may transmit, to the second UE over the direct link, an instruction to transmit a reference signal in a first sidelink interference measurement resource of the one or more sidelink interference measurement resources. The BS may also transmit, to the first UE associated with the first sidelink, an instruction to determine an interference measurement associated with the first sidelink interference measurement resource.

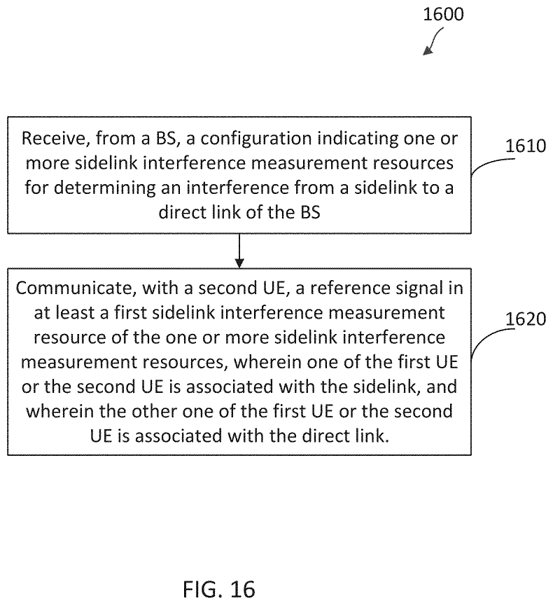

FIG. 16 is a flow diagram of a wireless communication method 1600 according to some aspects of the present disclosure. Aspects of the method 1600 can be executed by a computing device (e.g., a processor, processing circuit, and/or other suitable component) of a wireless communication device or other suitable means for performing the steps. For example, a wireless communication device, such as the UEs 115 or 315, may utilize one or more components, such as the processor 1402, the memory 1404, the interference module 1408, the communication module 1409, the transceiver 1410, the modem 1412, and the one or more antennas 1416, to execute the steps of method 1600. The method 1600 may employ similar mechanisms as described above in FIGS. 2-12. As illustrated, the method 1600 includes a number of enumerated steps, but aspects of the method 1600 may include additional steps before, after, and in between the enumerated steps. In some aspects, one or more of the enumerated steps may be omitted or performed in a different order.

At block 1610, a first UE receives, from a BS, a configuration indicating one or more sidelink interference measurement resources for determining an interference from a sidelink to a direct link of the BS. In some aspects, the first UE may receive the configuration based on the sidelink sharing a downlink resource of the direct link. In some instances, the first UE may utilize one or more components, such as the processor 1402, the memory 1404, the interference module 1408, the communication module 1409, the transceiver 1410, the modem 1412, and the one or more antennas 1416, to receive the configuration indicating the one or more sidelink interference measurement resources.

At block 1620, the first UE communicates, with a second UE, a reference signal in at least a first sidelink interference measurement resource of the one or more sidelink interference measurement resources, where one of the first UE or the second UE is associated with the sidelink, and the other one of the first UE or the second UE is associated with the direct link. In some instances, the first UE may utilize one or more components, such as the processor 1402, the memory 1404, the interference module 1408, the communication module 1409, the transceiver 1410, the modem 1412, and the one or more antennas 1416, to communicate the reference signal in at least the first sidelink interference measurement resource.

In some aspects, the configuration may further indicate at least one of a measurement report type, a reference signal type, a bandwidth, a subcarrier spacing, a sidelink traffic priority, or a direct link traffic priority associated with the one or more sidelink interference measurement resources, for example, as discussed above in relation to FIG. 5.

In some aspects, the first UE is associated with the sidelink and the second UE is associated with the direct link of the BS. For instance, the first UE may correspond to the sidelink transmitting UE 315a and the second UE may correspond to the direct link receiving UE 315c. The communicating the reference signal at block 1620 may include transmitting, in the first sidelink interference measurement resource, the reference signal based on the configuration, for example, as discussed above in relation to FIG. 4. The first UE may further monitor for an interference feedback indication and determine whether to transmit a sidelink communication signal in a resource (e.g., a DL resource) shared by the direct link and the sidelink, for example, as discussed above in relation to FIGS. 7-10.

In some aspects, the first UE is associated with the sidelink and the second UE is associated with the direct link of the BS. For instance, the first UE may correspond to the sidelink transmitting UE 315a and the second UE may correspond to the direct link receiving UE 315c. The communicating the reference signal at block 1620 may include receiving, from the second UE in the first sidelink interference measurement resource, the reference signal, for example, as discussed above in relation to FIGS. 11-12. The first UE may also determine at least one of an interference measurement (e.g., RSRP or RSSI), interference directional information, or a traffic priority of the direct link based on the received reference signal. The first UE may also determine whether to transmit a sidelink communication signal over the sidelink based on the at least one of the interference measurement, the interference directional information, or the traffic priority of the direct link, for example, as discussed above in relation to FIGS. 11-12.

In some aspects, the first UE is associated with the direct link of the BS and the second UE is associated with the sidelink. For instance, the first UE may correspond to the direct link receiving UE 315c and the second UE may correspond to the sidelink transmitting UE 315a. The communicating the reference signal at block 1620 may include receiving, from the second UE in the first sidelink interference measurement resource, the reference signal. The first UE may further determine at least one of an interference measurement (e.g., RSRP or RSSI), directional interference information, an identifier of the second UE, or a traffic priority of the sidelink based on the reference signal. The first UE may further transmit a measurement report including the to the BS, for example, as discussed above in relation to FIG. 4. In some aspects, the first UE may also determine an interference feedback indication for the second UE or relay an interference feedback indication from the BS to the second UE, for example, as discussed above in relation to FIGS. 9-10.

In some aspects, the first UE is associated with the direct link and the second UE is associated with the sidelink. For instance, the first UE may correspond to the direct link receiving UE 315c and the second UE may correspond to the sidelink transmitting UE 315a. The communicating the reference signal at block 1620 may include transmitting, in the first sidelink interference measurement resource, the reference signal based on the configuration, for example, as discussed above in relation to FIGS. 11-12.

Further aspects of present disclosure are provided below:

Aspect 1 includes a method of wireless communication performed by a base station (BS), the method comprising determining one or more sidelink interference measurement resources for determining an interference from at least a first sidelink to a direct link, the first sidelink associated with a first user equipment (UE), and the direct link being between the BS and a second UE different from the first UE; and transmitting, to at least one of the first UE or the second UE, a configuration indicating the one or more sidelink interference measurement resources.

Aspect 2 includes the method of aspect 1, wherein the determining the one or more sidelink interference measurement resources is based on the first sidelink sharing a downlink resource of the direct link.

Aspect 3 includes the method of aspect 1, wherein the configuration further indicates at least one of a measurement report type, a reference signal type, a bandwidth, a subcarrier spacing, a sidelink traffic priority, or a direct link traffic priority associated with the one or more sidelink interference measurement resources.

Aspect 4 includes the method of aspect 3, wherein the configuration further indicates at least one of a reference signal received power (RSRP) measurement or a received signal strength indicator (RSSI) to be reported based on the one or more sidelink interference measurement resources.

Aspect 5 includes the method of aspect 3, wherein the configuration further indicates at least one of a wideband reference signal or a narrowband reference signal to be transmitted in the one or more sidelink interference measurement resources.

Aspect 6 includes the method of aspect 3, wherein the configuration further indicates at least one of a sounding reference signal (SRS), a channel state information-reference signal (CSI-RS), a demodulation reference signal (DMRS), or a sidelink synchronization signal to be transmitted in the one or more sidelink interference measurement resources.

Aspect 7 includes the method of aspect 3, wherein the configuration further indicates a first sidelink interference measurement resource of the one or more sidelink interference measurement resources and a second sidelink interference measurement resource of the one or more sidelink interference measurement resources being associated with different traffic priorities.

Aspect 8 includes the method of any of aspects 1-7, wherein the method further comprises transmitting, in a downlink resource, a downlink communication signal rate-matched around a first interference measurement resource of the one or more sidelink interference measurement resources that is at least partially overlapping with the downlink resource.

Aspect 9 includes the method of any of aspects 1-7, wherein the method further comprises refraining from scheduling an uplink transmission in an uplink resource based on a first interference measurement resource of the one or more sidelink interference measurement resources being at least partially overlapping with the uplink resource.

Aspect 10 includes the method of any of aspects 1-7, wherein the method further comprises transmitting, to the first UE associated with the first sidelink, an instruction to transmit a reference signal in a first sidelink interference measurement resource of the one or more sidelink interference measurement resources, the transmitting the instruction to the first UE based on the first UE causing the interference; and transmitting, to the second UE over the direct link, an instruction to report an interference measurement based on the first sidelink interference measurement resource.

Aspect 11 includes the method of aspect 10, wherein the method further comprises receiving, from the second UE based on the reference signal, a measurement report including at least one of the interference measurement associated with the first sidelink, an identifier of the first UE associated with the first sidelink, or a traffic priority associated with the first sidelink; and determining, based on the measurement report, whether to transmit a downlink communication signal to the second UE.

Aspect 12 includes the method of aspect 11, wherein the configuration further indicates a measurement report resource, and the receiving the measurement report comprises receiving, from the second UE in the measurement report resource, the measurement report.

Aspect 13 includes the method of aspect 11, wherein the method further comprises transmitting, to the second UE, a request for the measurement report.

Aspect 14 includes the method of aspect 11, wherein the receiving the measurement report comprises receiving, from the second UE, the measurement report based on at least one of a sounding reference signal (SRS), a channel state information-reference signal (CSI-RS), a demodulation reference signal (DMRS), or a sidelink synchronization signal in the first sidelink interference measurement resource, the measurement report including at least one of a reference signal received power (RSRP) measurement, a receive signal strength indicator (RSSI) measurement, or an interference directional information.

Aspect 15 includes the method of aspect 14, wherein the measurement report is based on the SRS from the first UE associated with the first sidelink, and the method further comprises determining, based on the measurement report, channel state information (CSI) associated with at least one of the first sidelink or the direct link.

Aspect 16 includes the method of aspect 11, wherein the method further comprises refraining, based on the measurement report indicating the first sidelink has a higher traffic priority than the direct link, from transmitting the downlink communication signal.

Aspect 17 includes the method of aspect 11, wherein the method further comprises transmitting, to the second UE, a scheduling grant for the downlink communication signal; and transmitting, to the second UE based on the measurement report indicating the first sidelink has a higher traffic priority than the direct link, an indication cancelling a transmission of the downlink communication signal.

Aspect 18 includes the method of aspect 11, wherein the method further comprises transmitting, to the second UE based on the measurement report indicating the first sidelink has a lower traffic priority than the direct link, the downlink communication signal using a first transmission power; or transmitting, to the second UE based on the measurement report indicating the first sidelink has a higher traffic priority than the direct link, the downlink communication signal using a second transmission power.

Aspect 19 includes the method of aspect 11, wherein the method further comprises transmitting, to the first UE based on the measurement report indicating the first sidelink has a lower traffic priority than the direct link, at least one of a sidelink transmission cancellation request or a sidelink power control configuration.

Aspect 20 includes the method of aspect 19, wherein the transmitting the at least one of the sidelink transmission cancellation request or the sidelink power control configuration comprises transmitting, to the first UE via the second UE, the at least one of the sidelink transmission cancellation request or the sidelink power control configuration.

Aspect 21 includes the method of aspect 19, wherein the one or more sidelink interference measurement resources are configured for a group of UEs associated with sidelinks for reference signal signals, the group of UEs including the first UE, and the sidelinks including the first sidelink, and the transmitting the at least one of the sidelink transmission cancellation request or the sidelink power control configuration comprises transmitting, to the group of UEs, group common downlink control information (GC DCI) including the at least one of the sidelink transmission cancellation request or the sidelink power control configuration.

Aspect 22 includes the method of any of aspects 1-7, wherein the method further comprises transmitting, to the second UE over the direct link, an instruction to transmit a reference signal in a first sidelink interference measurement resource of the one or more sidelink interference measurement resources; and transmitting, to the first UE associated with the first sidelink, an instruction to determine an interference measurement associated with the first sidelink interference measurement resource.

Aspect 23 includes the method of aspect 22, wherein the method further comprises transmitting, to the second UE over the direct link during a first time period, a scheduling grant for a downlink communication signal in a shared resource shared by the first sidelink and the direct link; and transmitting, to the second UE over the direct link in the shared resource during a second time period, the downlink communication signal, the first time period and the second time period being spaced apart by a third time period including the first sidelink interference measurement resource.

Aspect 24 includes the method of aspect 23, wherein the method further comprises transmitting, to the first UE based on a traffic priority of the downlink communication signal, at least one of a sidelink transmission cancellation request or a sidelink power control configuration.

Aspect 25 includes the method of aspect 24, wherein the one or more sidelink interference measurement resources are configured for a group of UEs associated with sidelinks for reference signal transmissions, the group of UEs including the first UE, and the sidelinks including the first sidelink, and the transmitting the at least one of the sidelink transmission cancellation request or the sidelink power control configuration comprises transmitting, to the group of UEs, group common-downlink control information (GC DCI) including the at least one of the sidelink transmission cancellation request or the sidelink power control configuration.

Aspect 26 includes a method of wireless communication performed by a first user equipment (UE), the method comprising receiving, from a BS, a configuration indicating one or more sidelink interference measurement resources for determining an interference from a sidelink to a direct link of the BS; and communicating, with a second UE, a reference signal in at least a first sidelink interference measurement resource of the one or more sidelink interference measurement resources, wherein one of the first UE or the second UE is associated with the sidelink, and wherein the other one of the first UE or the second UE is associated with the direct link.

Aspect 27 includes the method of aspect 26, wherein the receiving the configuration is based on the sidelink sharing a downlink resource of the direct link.

Aspect 28 includes the method of aspect 26, wherein the configuration further indicates at least one of a measurement report type, a reference signal type, a bandwidth, a subcarrier spacing, a sidelink traffic priority, or a direct link traffic priority associated with the one or more sidelink interference measurement resources.

Aspect 29 includes the method of any of aspects 26-28, wherein the first UE is associated with the sidelink and the second UE is associated with the direct link of the BS, and the communicating the reference signal comprises transmitting, in the first sidelink interference measurement resource, the reference signal based on the configuration.

Aspect 30 includes the method of aspect 29, wherein the communicating the reference signal further comprises transmitting, in the first sidelink interference measurement resource, at least one of a sounding reference signal (SRS), a channel state information-reference signal (CSI-RS), a demodulation reference signal (DMRS), or a sidelink synchronization signal based on the configuration.

Aspect 31 includes the method of aspect 29, wherein the configuration indicates different sidelink traffic priorities for at least the first sidelink interference measurement resource and a second sidelink interference measurement resource of the one or more sidelink interference measurement resources, and the communicating the reference signal further comprises transmitting, in the first sidelink interference measurement resource based on a traffic priority associated with the sidelink, the reference signal.

Aspect 32 includes the method of aspect 29, wherein the communicating the reference signal further comprises transmitting the reference signal based on the first UE having data ready for transmission over the sidelink.

Aspect 33 includes the method of aspect 29, wherein the method further comprises monitoring for an interference feedback indication; and determining whether to transmit a sidelink communication signal over the sidelink based on the monitoring.

Aspect 34 includes the method of aspect 33, wherein the configuration further indicates a feedback resource associated with the first sidelink interference measurement resource, and the monitoring comprises monitoring, in the feedback resource, for the interference feedback indication.

Aspect 35 includes the method of aspect 33, wherein the monitoring comprises receiving at least one of a unicast message, a multicast message, a broadcast message, or a group common-downlink control information (GC-DCI) including the interference feedback indication.

Aspect 36 includes the method of aspect 33, wherein the method further comprises refraining from transmitting the sidelink communication signal in response to receiving the interference feedback indication from the monitoring.

Aspect 37 includes the method of aspect 33, wherein the method further comprises transmitting, in response to determining no interference feedback indication is received from the monitoring, the sidelink communication signal using a first transmission power; or transmitting, in response to determining no interference feedback indication is received from the monitoring, the sidelink communication signal using a second transmission power.

Aspect 38 includes the method of any of aspects 26-28, wherein the first UE is associated with the sidelink and the second UE is associated with the direct link of the BS, and the communicating the reference signal comprises receiving, from the second UE in the first sidelink interference measurement resource, the reference signal.

Aspect 39 includes the method of aspect 38, wherein the communicating the reference signal further comprises receiving, from the second UE in the first sidelink interference measurement resource, at least one of clear-to-send (CTS) signal, a sounding reference signal (SRS), a channel state information-reference signal (CSI-RS), a demodulation reference signal (DMRS), or a sidelink synchronization signal.

Aspect 40 includes the method of aspect 38, wherein the method further comprises refraining from transmitting a sidelink communication signal over the sidelink in response to receiving the reference signal.

Aspect 41 includes the method of aspect 38, wherein the method further comprises determining, based on the configuration, at least one of an interference measurement, interference directional information, or a traffic priority of the direct link based on the received reference signal; and determining whether to transmit a sidelink communication signal over the sidelink based on the at least one of the interference measurement, the interference directional information, or the traffic priority of the direct link.

Aspect 42 includes the method of aspect 41, wherein the determining the at least one of the interference measurement, the interference directional information, or the traffic priority of the direct link comprises determining at least one of a reference signal received power (RSRP) measurement or a receive signal strength indication (RSSI) for the received reference signal.

Aspect 43 includes the method of aspect 41, wherein the determining the at least one of an interference measurement, the interference directional information, or the traffic priority of the direct link comprises determining the traffic priority of the direct link based on a priority associated with the first sidelink interference measurement resource in which the reference signal is received.

Aspect 44 includes the method of aspect 43, wherein the method further comprises refraining from transmitting the sidelink communication signal based on the traffic priority of the direct link being higher than a traffic priority of the sidelink communication signal.

Aspect 45 includes the method of aspect 43, wherein the method further comprises transmitting, based on the traffic priority of the direct link being lower than a traffic priority of the sidelink communication signal, the sidelink communication signal using a first transmission power; or transmitting, based on the traffic priority of the direct link being higher than a traffic priority of the sidelink communication signal, the sidelink communication signal using a second transmission power.

Aspect 46 includes the method of aspect 43, wherein the method further comprises monitoring for an interference feedback indication, wherein the determining whether to transmit the sidelink communication signal is further based on the monitoring.

Aspect 47 includes the method of aspect 43, wherein the method further comprises transmitting, during a first time period, a sidelink scheduling grant for the sidelink communication signal in a second time period, wherein the communicating the reference signal comprises receiving, in the first sidelink interference measurement resource during a third time period between the first time period and the second time period, the reference signal.

Aspect 48 includes the method of aspect 38, wherein the method further comprises transmitting, during a first time period, a sidelink scheduling grant for a sidelink communication signal in a second time period; monitoring, a second sidelink interference measurement resource of the sidelink interference measurement resources during a third time period between the first time period and the second time period, for a clear-to-send (CTS) signal; and transmitting, over the sidelink, the sidelink communication signal in response to determining no CTS signal is received in the second sidelink interference measurement resource.

Aspect 49 includes the method of any of aspects 26-28, wherein the first UE is associated with the direct link of the BS and the second UE is associated with the sidelink, and the communicating the reference signal comprises receiving, from the second UE in the first sidelink interference measurement resource, the reference signal.

Aspect 50 includes the method of aspect 49, wherein the communicating the reference signal further comprises receiving, from the second UE in the first sidelink interference measurement resource, at least one of a sounding reference signal (SRS), a channel state information-reference signal (CSI-RS), a demodulation reference signal (DMRS), or a sidelink synchronization signal.

Aspect 51 includes the method of aspect 49, wherein the method further comprises determining, based on the configuration, at least one of an interference measurement, directional interference information, an identifier of the second UE, or a traffic priority of the sidelink based on the reference signal.

Aspect 52 includes the method of aspect 51, wherein the determining the at least one of the interference measurement, the directional interference information, the identifier of the second UE, or the traffic priority of the sidelink comprises determining at least one of a reference signal received power (RSRP) measurement or a receive signal strength indication (RSSI) based on the reference signal.

Aspect 53 includes the method of aspect 51, wherein the determining the at least one of the interference measurement, directional interference information, the identifier of the second UE, or the traffic priority of the sidelink comprises determining the traffic priority of the sidelink based on a priority associated with the first sidelink interference measurement resource in which the reference signal is received, the method further comprises transmitting, to the second UE associated with the sidelink based on the direct link having a higher traffic priority than the sidelink, an interference feedback indication.

Aspect 54 includes the method of aspect 51, wherein the method further comprises transmitting, to the BS, a measurement report including the at least one of the interference measurement, the directional interference information, the identifier of the second UE, or the traffic priority of the sidelink.

Aspect 55 includes the method of aspect 54, wherein the method further comprises receiving, from the BS in response to the measurement report, an interference feedback indication for the second UE; and transmitting, to the second UE associated with the sidelink, the interference feedback indication.

Aspect 56 includes the method of aspect 54, wherein the method further comprises receiving, from the BS, a scheduling grant for a downlink communication signal; and receiving, from the BS in response to the measurement report, an indication cancelling a transmission of the downlink communication signal.

Aspect 57 includes the method of any of aspects 26-28, wherein the first UE is associated with the direct link and the second UE is associated with the sidelink, and the communicating the reference signal comprises transmitting, in the first sidelink interference measurement resource, the reference signal based on the configuration.

Aspect 58 includes the method of aspect 57, wherein the communicating the reference signal further comprises transmitting, in the first sidelink interference measurement resource, at least one of a clear-to-send (CTS) signal, a sounding reference signal (SRS), a channel state information-reference signal (CSI-RS), a demodulation reference signal (DMRS), or a sidelink synchronization signal.

Aspect 59 includes the method of aspect 57, wherein the configuration indicates different direct link traffic priorities for at least the first sidelink interference measurement resource and a second sidelink interference measurement resource of the one or more sidelink interference measurement resources, and the communicating the reference signal further comprises transmitting, in the first sidelink interference measurement resource based on a traffic priority associated with the direct link, the reference signal.

Aspect 60 includes the method of aspect 57, wherein the method further comprises receiving, from the BS, a scheduling grant for a downlink communication signal in a resource; and receiving, from the BS, a trigger to transmit the reference signal based on the resource being shared by the direct link and the sidelink.

Aspect 61 includes the method of aspect 60, wherein the receiving the scheduling grant comprises receiving, from the BS during a first time period, the scheduling grant, and the method further comprises receiving, from the BS during a second time period, the downlink communication signal, wherein the first time period and the second time period are spaced apart by a third time period including the first sidelink interference measurement resource.

Aspect 62 includes the method of aspect 60, wherein the method further comprises transmitting, to the BS before receiving the scheduling grant, an interference measurement report, wherein the receiving the trigger to transmit the reference signal is based on the interference measurement report.

Aspect 63 includes an apparatus comprising a processor coupled to a transceiver, wherein the processor and transceiver are configured to perform the method of any one of aspects 1-25.

Aspect 64 includes an apparatus comprising means for performing the method of any one of aspects 1-25.

Aspect 65 includes a non-transitory computer readable medium including program code, which when executed by one or more processors, causes a wireless communication device to perform the method of any one of aspects 1-25.

Aspect 66 includes an apparatus comprising a processor coupled to a transceiver, wherein the processor and transceiver are configured to perform the method of any one of aspects 26-62.

Aspect 67 includes an apparatus comprising means for performing the method of any one of aspects 26-62.

Aspect 68 includes a non-transitory computer readable medium including program code, which when executed by one or more processors, causes a wireless communication device to perform the method of any one of aspects 26-62.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a first user equipment (UE), the method comprising:
receiving, from a BS, a configuration indicating one or more sidelink interference measurement resources for determining an interference from a sidelink to a direct link of the BS; and
communicating, with a second UE, a reference signal in at least a first sidelink interference measurement resource of the one or more sidelink interference measurement resources, wherein one of the first UE or the second UE is associated with the sidelink, and wherein the other one of the first UE or the second UE is associated with the direct link.

2. The method of claim 1, wherein the receiving the configuration is based on the sidelink sharing a downlink resource of the direct link.

3. The method of claim 1, wherein the configuration further indicates at least one of a measurement report type, a reference signal type, a bandwidth, a subcarrier spacing, a sidelink traffic priority, or a direct link traffic priority associated with the one or more sidelink interference measurement resources.

4. The method of claim 1, wherein:
the first UE is associated with the sidelink and the second UE is associated with the direct link of the BS, and
the communicating the reference signal comprises:
transmitting, in the first sidelink interference measurement resource, the reference signal based on the configuration.

5. The method of claim 1, wherein:
the first UE is associated with the sidelink and the second UE is associated with the direct link of the BS, and
the communicating the reference signal comprises:
receiving, from the second UE in the first sidelink interference measurement resource, the reference signal.

6. The method of claim 1, wherein:
the first UE is associated with the direct link of the BS and the second UE is associated with the sidelink, and
the communicating the reference signal comprises:
receiving, from the second UE in the first sidelink interference measurement resource, the reference signal.

7. The method of claim 6, further comprising:
transmitting, to the BS in response to receiving the reference signal, a measurement report including at least one of an interference measurement, directional interference information, an identifier of the second UE, or a traffic priority of the sidelink.

8. The method of claim 1, wherein:
the first UE is associated with the direct link and the second UE is associated with the sidelink, and
the communicating the reference signal comprises:
transmitting, in the first sidelink interference measurement resource, the reference signal based on the configuration.

9. A method of wireless communication performed by a base station (BS), the method comprising:
determining one or more sidelink interference measurement resources for determining an interference from at least a first sidelink to a direct link, the first sidelink associated with a first user equipment (UE), and the direct link being between the BS and a second UE different from the first UE; and
transmitting, to at least one of the first UE or the second UE, a configuration indicating the one or more sidelink interference measurement resources.

10. The method of claim 9, wherein the determining the one or more sidelink interference measurement resources is based on the first sidelink sharing a downlink resource of the direct link.

11. The method of claim 9, wherein the configuration further indicates at least one of a measurement report type, a reference signal type, a bandwidth, a subcarrier spacing, a sidelink traffic priority, or a direct link traffic priority associated with the one or more sidelink interference measurement resources.

12. The method of claim 9, further comprising:
transmitting, to the first UE associated with the first sidelink, an instruction to transmit a reference signal in a first sidelink interference measurement resource of the one or more sidelink interference measurement resources, the transmitting the instruction to the first UE based on the first UE causing the interference; and
transmitting, to the second UE over the direct link, an instruction to report an interference measurement based on the first sidelink interference measurement resource.

13. The method of claim 12, further comprising:
receiving, from the second UE based on the reference signal, a measurement report including at least one of an interference measurement associated with the first sidelink, directional interference information associated with the first sidelink, an identifier of the first UE associated with the first sidelink, or a traffic priority associated with the first sidelink.

14. The method of claim 13, wherein:
the configuration further indicates a measurement report resource, and
the receiving the measurement report comprises:
receiving, from the second UE in the measurement report resource, the measurement report.

15. The method of claim 13, further comprising:
transmitting, to the second UE, a request for the measurement report.

16. The method of claim 9, further comprising:
transmitting, to the second UE over the direct link, an instruction to transmit a reference signal in a first sidelink interference measurement resource of the one or more sidelink interference measurement resources; and
transmitting, to the first UE associated with the first sidelink, an instruction to determine an interference measurement associated with the first sidelink interference measurement resource.

17. A first user equipment (UE) comprising:
a memory;
a transceiver;
at least one processor coupled to the memory and the transceiver, wherein the at least one processor is configured to:
receive, from a BS via the transceiver, a configuration indicating one or more sidelink interference measurement resources for determining an interference from a sidelink to a direct link of the BS; and
communicate, with a second UE via the transceiver, a reference signal in at least a first sidelink interference measurement resource of the one or more sidelink interference measurement resources, wherein one of the first UE or the second UE is associated with the sidelink, and wherein the other one of the first UE or the second UE is associated with the direct link.

18. The first UE of claim 17, wherein the at least one processor configured to receive the configuration is configured to:
receive the configuration based on the sidelink sharing a downlink resource of the direct link.

19. The first UE of claim 17, wherein the configuration further indicates at least one of a measurement report type, a reference signal type, a bandwidth, a subcarrier spacing, a sidelink traffic priority, or a direct link traffic priority associated with the one or more sidelink interference measurement resources.

20. The first UE of claim 17, wherein:
the first UE is associated with the sidelink and the second UE is associated with the direct link of the BS, and
the at least one processor configured to communicate the reference signal is configured to:
transmit, in the first sidelink interference measurement resource, the reference signal based on the configuration.

21. The first UE of claim 17, wherein:
the first UE is associated with the sidelink and the second UE is associated with the direct link of the BS, and
the at least one processor configured to communicate the reference signal is configured to:
receive, from the second UE in the first sidelink interference measurement resource, the reference signal.

22. The first UE of claim 17, wherein:
the first UE is associated with the direct link of the BS and the second UE is associated with the sidelink, and
the at least one processor configured to communicate the reference signal is configured to:
receive, from the second UE in the first sidelink interference measurement resource, the reference signal.

23. The first UE of claim 22, wherein the at least one processor is further configured to:
transmit, to the BS in response to receiving the reference signal, a measurement report including at least one of an interference measurement, directional interference information, an identifier of the second UE, or a traffic priority of the sidelink.

24. The first UE of claim 17, wherein:
the first UE is associated with the direct link and the second UE is associated with the sidelink, and
the at least one processor configured to communicate the reference signal is configured to:
transmit, in the first sidelink interference measurement resource, the reference signal based on the configuration.

25. A base station (BS) comprising:
a memory;
a transceiver;
at least one processor coupled to the memory and the transceiver, wherein the at least one processor is configured to:
determine one or more sidelink interference measurement resources for determining an interference from at least a first sidelink to a direct link, the first sidelink associated with a first user equipment (UE), and the direct link being between the BS and a second UE different from the first UE; and
transmit, to at least one of the first UE or the second UE via the transceiver, a configuration indicating the one or more sidelink interference measurement resources.

26. The BS of claim 25, wherein the at least one processor configured to determine the one or more sidelink interference measurement resources is configured to:
determine the one or more sidelink interference measurement resources based on the first sidelink sharing a downlink resource of the direct link.

27. The BS of claim 25, wherein the configuration further indicates at least one of a measurement report type, a reference signal type, a bandwidth, a subcarrier spacing, a sidelink traffic priority, or a direct link traffic priority associated with the one or more sidelink interference measurement resources.

28. The BS of claim 25, wherein the at least one processor is further configured to:
transmit, to the first UE associated with the first sidelink, an instruction to transmit a reference signal in a first sidelink interference measurement resource of the one or more sidelink interference measurement resources, the instruction is transmitted to the first UE based on the first UE causing the interference; and
transmit, to the second UE over the direct link, an instruction to report an interference measurement based on the first sidelink interference measurement resource.

29. The BS of claim 25, wherein the at least one processor is further configured to:
receive, from the second UE based on the reference signal, a measurement report including at least one of an interference measurement associated with the first sidelink, directional interference information associated with the first sidelink, an identifier of the first UE associated with the first sidelink, or a traffic priority associated with the first sidelink.

30. The BS of claim 25, wherein the at least one processor is further configured to:
transmit, to the second UE over the direct link, an instruction to transmit a reference signal in a first sidelink interference measurement resource of the one or more sidelink interference measurement resources; and
transmit, to the first UE associated with the first sidelink, an instruction to determine an interference measurement associated with the first sidelink interference measurement resource.
